(19) United States
(12) Patent Application Publication
(10) Pub. No.: US 2022/0027249 A1
(43) Pub. Date: Jan. 27, 2022

(54) AUTOMATED METHODS AND SYSTEMS FOR TROUBLESHOOTING PROBLEMS IN A DISTRIBUTED COMPUTING SYSTEM

(71) Applicant: VMware, Inc., Palo Alto, CA (US)

(72) Inventors: Sunny Dua, Palo Alto, CA (US); Bonnie Zhang, Palo Alto, CA (US); Karen Aghajanyan, Yerevan (AM); Hovhannes Antonyan, Yerevan (AM); Ashot Nshan Harutyunyan, Yerevan (AM); Arnak Poghosyan, Yerevan (AM); Naira Movses Grigoryan, Yerevan (AM)

(73) Assignee: VMware, Inc., Palo Alto, CA (US)

(21) Appl. No.: 16/936,565

(22) Filed: Jul. 23, 2020

(51) Int. Cl. G06F 11/34; G06F 11/30; G06F 11/32; G06F 11/07; G06K 9/62

(52) U.S. Cl. CPC G06F 11/3409; G06F 11/3466; G06F 11/3034; G06K 9/6215; G06F 11/076; G06K 9/6212; G06F 11/324

(57) ABSTRACT

Methods and systems described herein automate various aspects of troubleshooting a problem in a distributed computing system for various forms of object information regarding objects of the distributed computing system. In one aspect, the object information includes metrics, log messages, properties, network flows, events, and application traces. Methods and systems learn interesting patterns contained in the object information. The interesting patterns include change points in metrics and network flows, changes in the types of log messages, broken correlations between events, anomalous event transactions, atypical histogram distributions of metrics, and atypical histogram distributions of span durations in application traces. The interesting patterns are displayed in a graphical user interface (“GUI”) that enables a user to assign a label identifying a problem associated with the interesting patterns.

### TECHNICAL FIELD

This disclosure is directed to troubleshooting performance problems in a distributed computing system.

### BACKGROUND

In recent years, large distributed computing systems have been built to meet the increasing demand for information technology (“IT”) services, such as running applications for organizations that provide business and web services to millions of customers. Data centers, for example, execute thousands of applications that enable businesses, governments, and other organizations to offer services over the Internet. These organizations cannot afford problems that result in downtime or slow performance of their applications. Performance issues can frustrate users, damage a brand name, result in lost revenue, and deny people access to vital services.

In order to aid system administrators and application owners with detection of problems, various management tools have been developed to collect performance information, such as metrics and log message, to aid in troubleshooting and root cause analysis of problems with applications, services, and hardware. However, typical management tools are not able to troubleshoot the causes of many types of performance problems from the information collected. As a result, system administrators and application owners manually troubleshoot performance problems which is time consuming, costly, and can lead to lost revenue. For example, a typical management tool generates an alert when the response time of a service to a request from a client exceeds a response time threshold. As a result, system administrators are made aware of the problem when the alert is generated. But system administrators may not be able to timely troubleshoot the cause of the delayed response time because the cause may be the result of performance problems occurring with hardware and/or software executing elsewhere in the data center. Moreover, alerts and parameters for detecting the performance problems may not be defined and many alerts fail to point to a root causes of a performance problem. Identifying potential root causes of a performance issue within a large distributed computing facility is a challenging problem. System administrators and application owners seek methods and systems that can find and troubleshoot performance problems in a distributed computing facility.

### SUMMARY

Methods and systems described herein automate troubleshooting a problem in a distributed computing system while utilizing various forms of object information regarding objects of the distributed computing system. The object information is obtained from monitoring the underlying infrastructure of the system and applications executing in the system. In one aspect, the object information includes metrics, log messages, properties, network flows, events, and application traces. Methods and systems learn interesting patterns contained in the object information. The interesting patterns include change points in metrics and network flows, changes in the types of log messages, broken correlations between events, anomalous event transactions, atypical histogram distributions of metrics, and atypical histogram distributions of span durations in application traces. The interesting patterns are displayed in a graphical user interface (“GUI”) that enables a user to assign a label identifying a problem associated with the interesting patterns.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine (“VM”) and VM execution environments.

FIG. 6 shows an example of an open virtualization format package.

FIG. 7 shows example virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a virtualization layer located above a physical data center.

FIGS. 14A-14B shows an operations manager that receives object information from various physical and virtual objects.

FIGS. 15A-15B show examples of object topologies of objects of a distributed computing system.

FIG. 16 shows an example of stages of an automated troubleshooting process.

FIG. 17 shows an example automated workflow for troubleshooting problems in a distributed computing system.

FIG. 18 shows a plot of an example of a metric.

FIG. 19 shows a plot of an example metric in which the mean value for metric values of the metric shifted.

FIG. 20A shows a plot of time-series metric data within a sliding time window used to detect a change point.

FIG. 20B shows graphs and a statistic computed for metric values in the left-hand and right-hand windows of a sliding time window.

FIG. 20 shows an example of logging log messages in log files.

FIG. 21A show an example of a Boolean property metric of an object.

FIG. 21B show an example of a counter property metric associated with an object.

FIG. 22A shows an example plot of a metric over a time period partitioned into a historical time period and a run-time period.

FIG. 22B shows an example plot of two dimensions of abnormality and corresponding abnormality scores.

FIG. 23 shows an example of logging log messages in log files.

FIG. 24 shows an example source code of an event source that generates log messages.

FIG. 25 shows an example of a log write instruction.

FIG. 26 shows an example of a log message generated by the log write instruction shown in FIG. 25.

FIG. 27 shows an example of eight log message entries of a log file.

FIG. 28 shows an example of event analysis performed on an example error log message.

FIG. 29 shows a plot of examples of trends in error, warning, and informational log messages.

FIGS. 30A-30B show examples of log messages partitioned into two sets of log messages.

FIG. 31 shows event-type logs obtained from the two set of log messages in FIG. 30A.

FIG. 32 shows determination of sentiment scores and criticality scores for a list of events recorded in a troubleshooting time period.

FIG. 33 shows an example correlation matrix.

FIG. 34 shows an example of QR decomposition of a correlation matrix.

FIG. 35 shows an example of a directed graph formed from eight events.

FIG. 36 shows an example of a histogram distribution over a time period.

FIGS. 37A-37B show an example of a distribute application and an example application trace.

FIGS. 38A-38B show two examples of erroneous traces associated with the services represented in FIG. 37A.

FIGS. 39A-39B show an example of a graphical user interface (“GUI”) that list interesting patterns and enables a user to label the interesting patterns.

FIG. 40 is a flow diagram illustrating an example implementation of a “method for troubleshooting problems in a distributed computing system.”

FIG. 41 is a flow diagram illustrating an example implementation of the “learn interesting patterns in the object information” procedure performed in FIG. 40.

FIG. 42 is a flow diagram illustrating an example implementation of the “learn interesting patterns in metrics” procedure performed in FIG. 41.

FIG. 43 is a flow diagram illustrating an example implementation of the “learn interesting patterns in log messages” procedure performed in FIG. 41.

FIG. 44 is a flow diagram illustrating an example implementation of the “learn interesting patterns in breakage of correlations between events” procedure performed in FIG. 41.

FIG. 45 is a flow diagram illustrating an example implementation of the “determine correlated metrics” procedure performed in FIG. 44.

FIG. 46 is a flow diagram illustrating an example implementation of the “learn interesting patterns in outlier histogram distributions of metrics” procedure performed in FIG. 41.

FIG. 47 is a flow diagram illustrating an example implementation of the “construct a directed graph from the events and conditional probabilities related to each pair of events” procedure performed in FIG. 46.

FIG. 48 is a flow diagram illustrating an example implementation of the “learn interesting patterns in outlier histogram distributions of metrics” procedure performed in FIG. 41.

### DETAILED DESCRIPTION

This disclosure presents automated methods and systems for troubleshooting a problem in a distributed computing facility. In a first subsection, computer hardware, complex computational systems, and virtualization are described. Automated methods and systems for troubleshooting a problem in a distributed computing facility are described below in a second subsection.

Computer Hardware, Complex Computational Systems, and Virtualization

The term “abstraction” as used to describe virtualization below is not intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces.

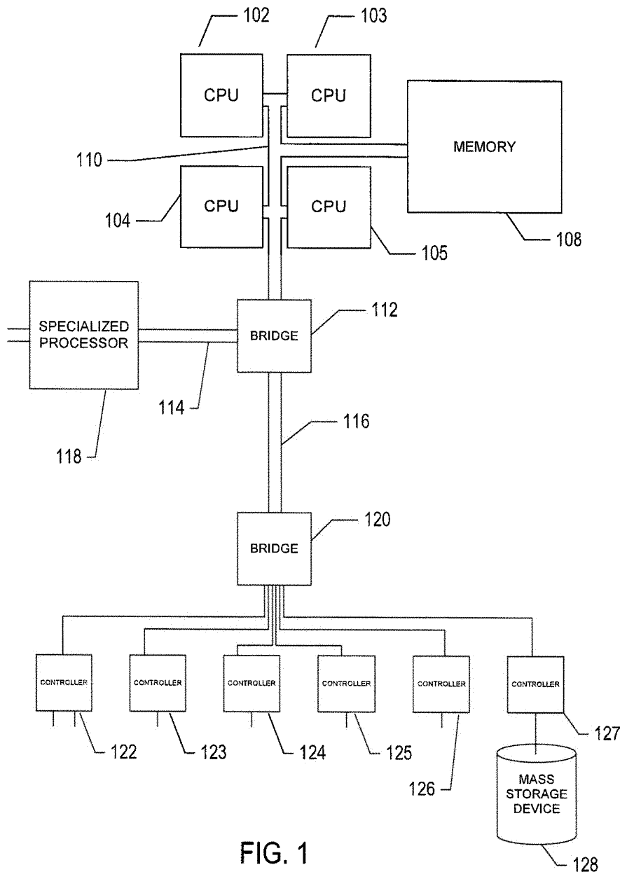

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

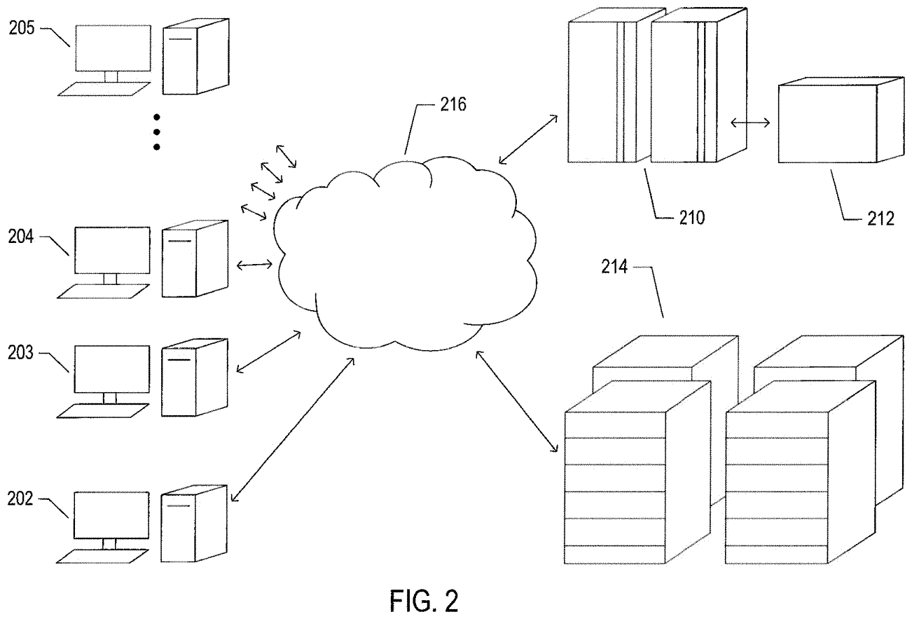

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

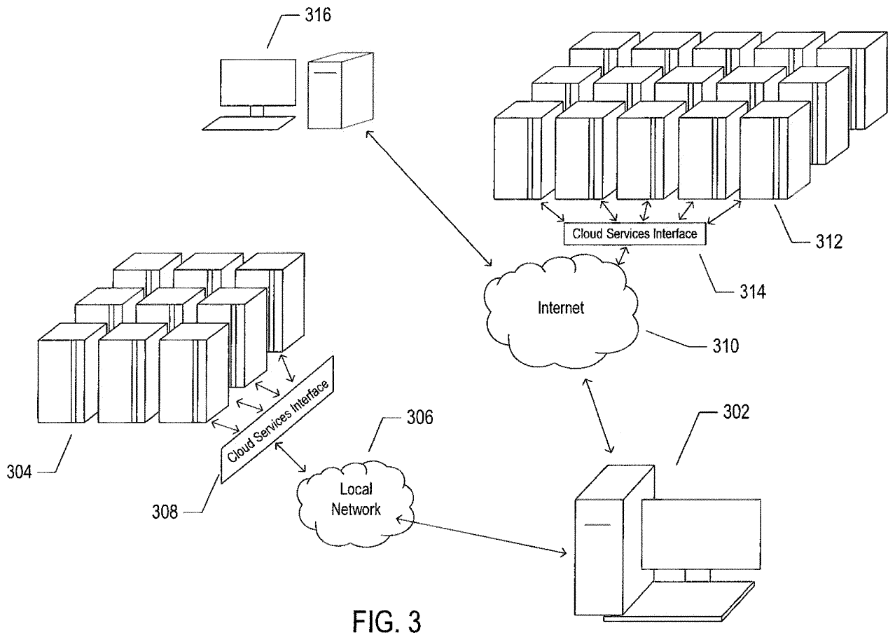

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

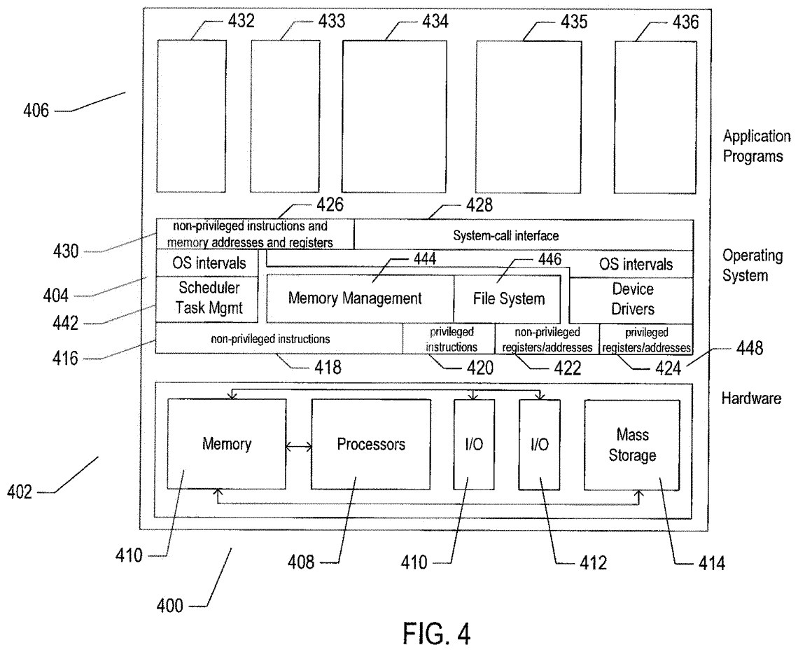

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

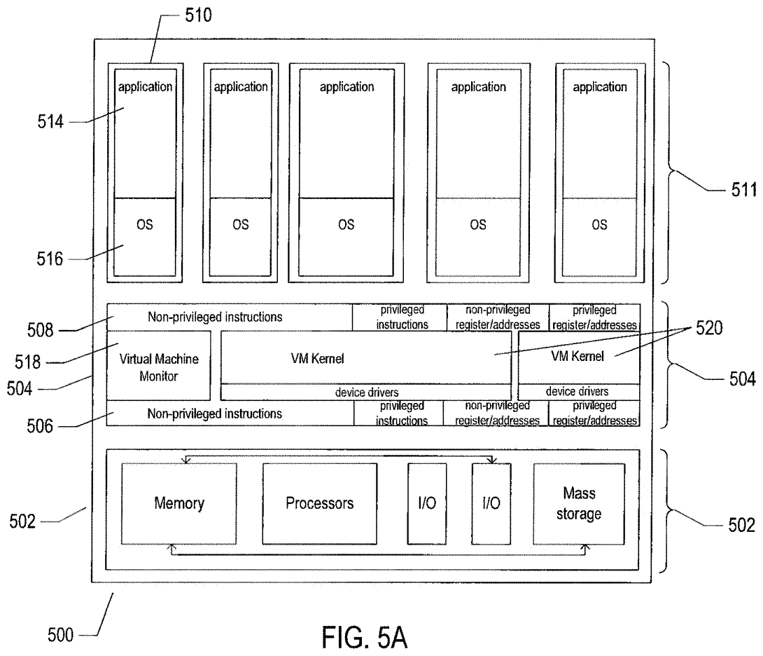

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution z environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS.” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

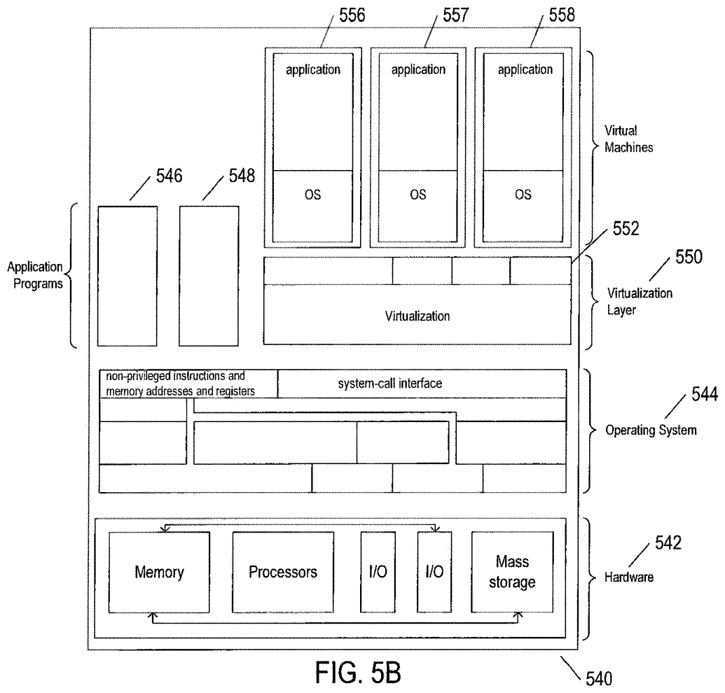

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

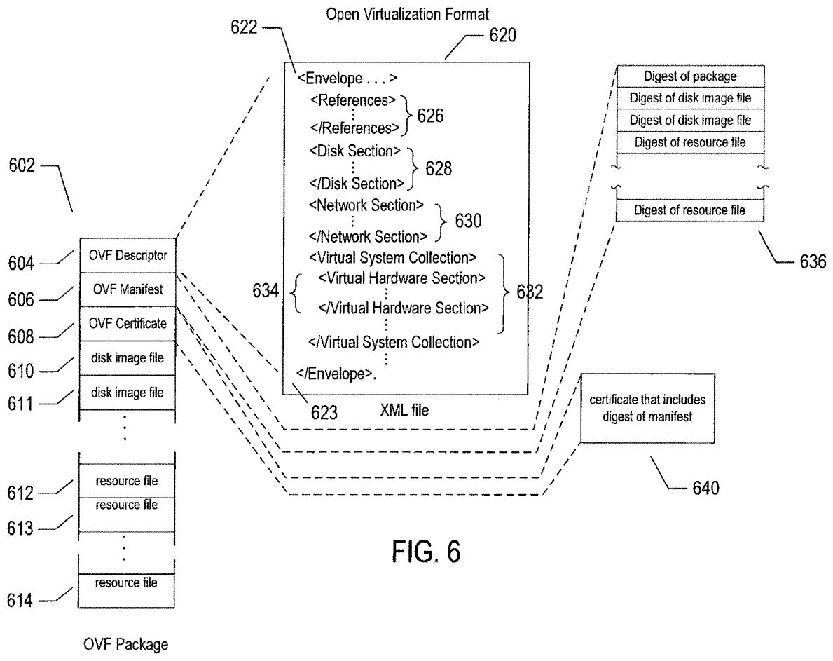

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

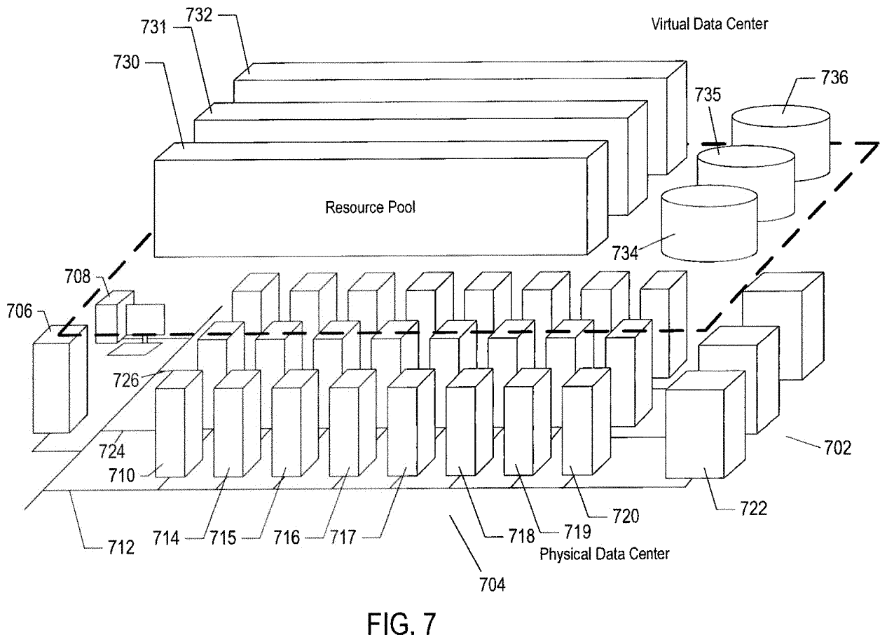

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to an individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

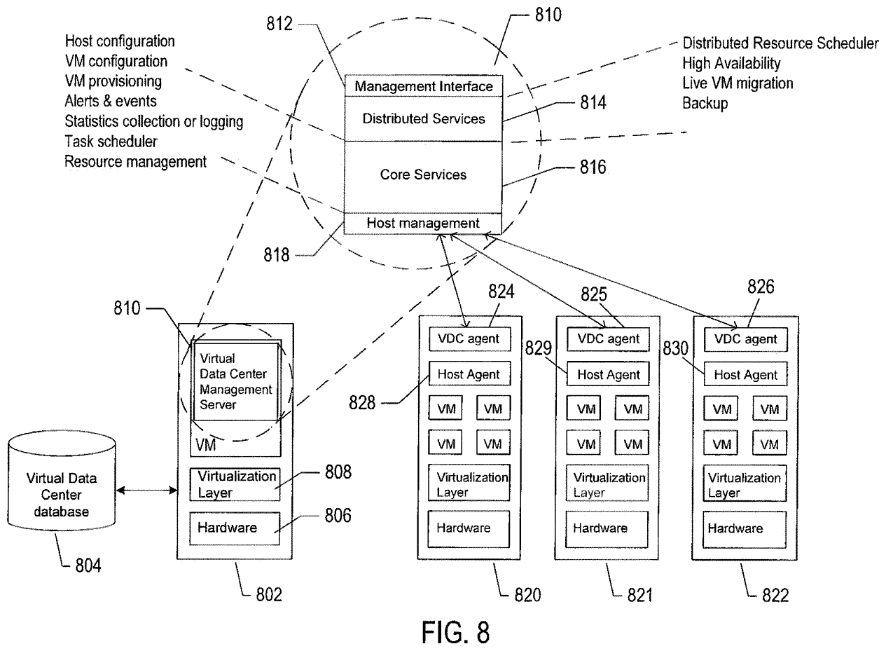

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

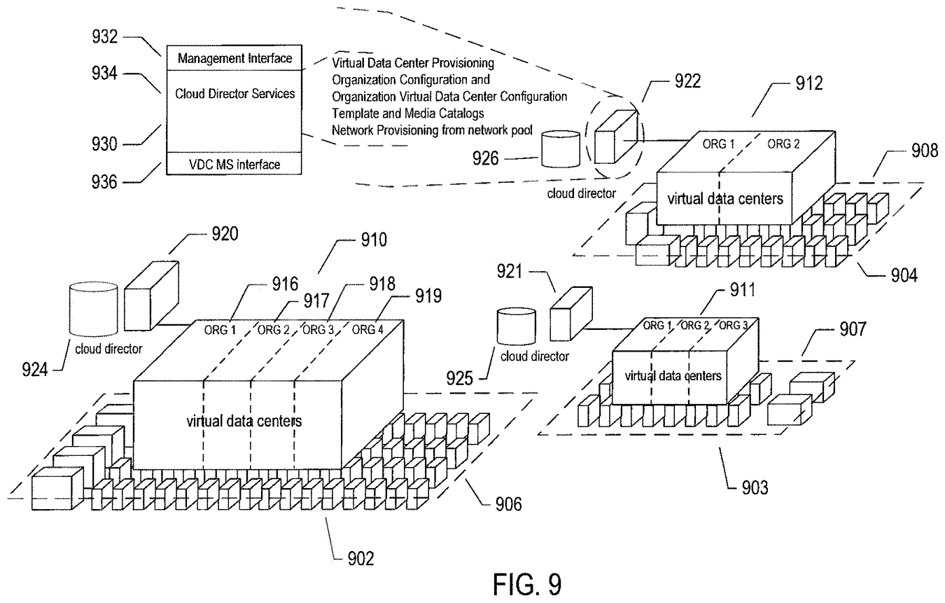

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

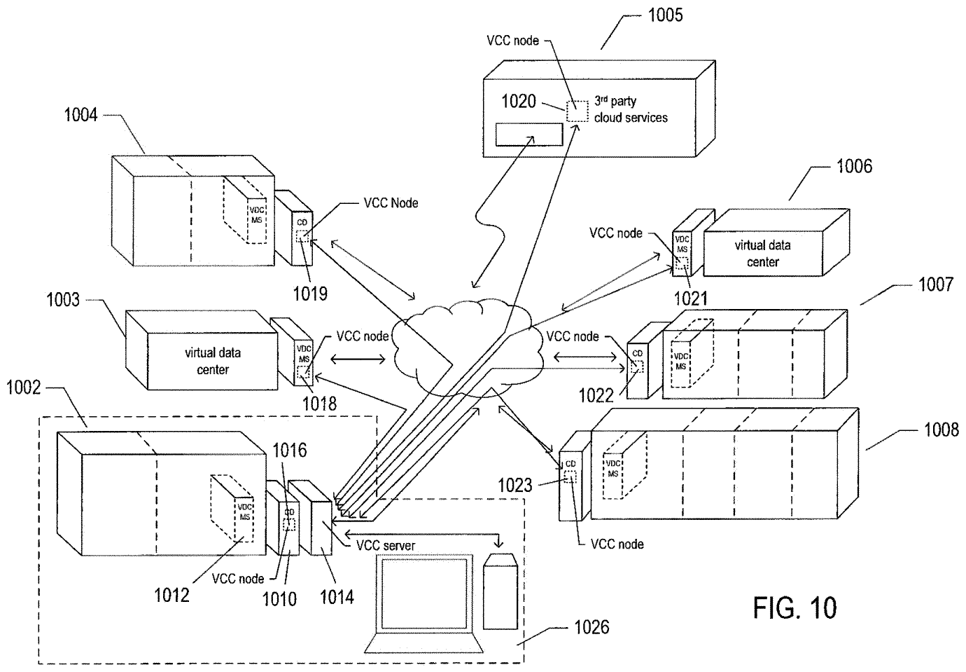

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404. OSL virtualization involves an OSL virtualization layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

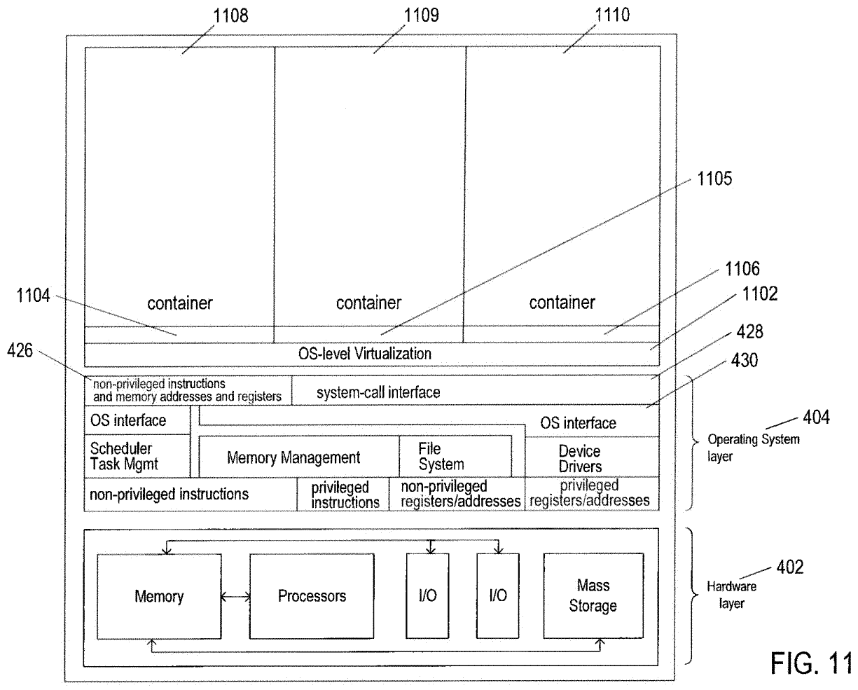

FIG. 12 shows an approach to implementing the containers on a VM. FIG. 12 shows a host computer similar to that shown in FIG. 5A, discussed above. The host computer includes a hardware layer 502 and a virtualization layer 504 that provides a virtual hardware interface 508 to a guest operating system 1102. Unlike in FIG. 5A, the guest operating system interfaces to an OSL-virtualization layer 1104 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Automated Methods and Systems for Troubleshooting Performance Problems in a Distributed Computing Facility

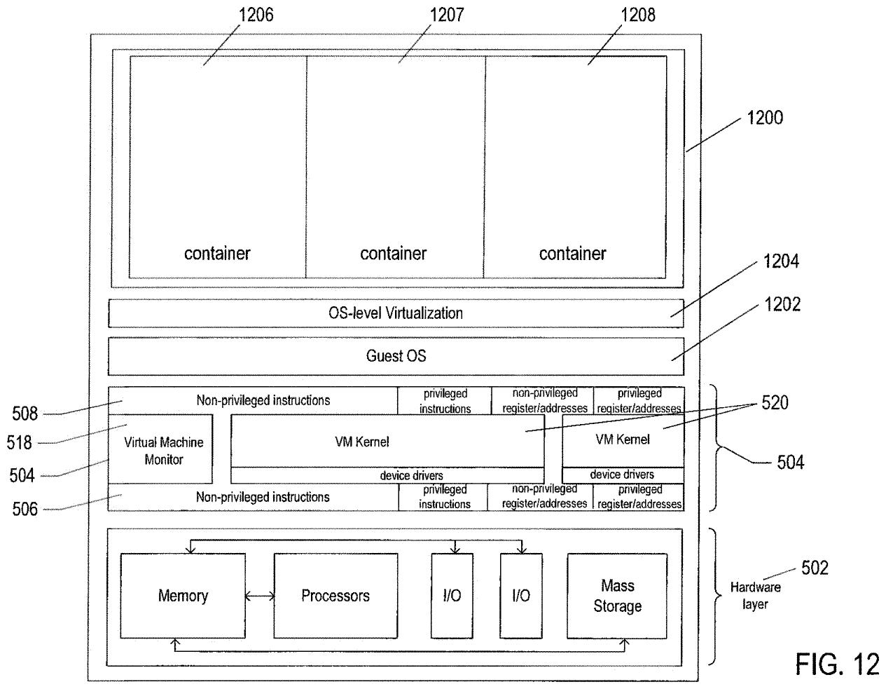

A cloud service degradation or non-optimal performance of an application or hardware of a distributed computing system can originate both from the infrastructure of the system and/or different application layers of the system. FIG. 13 shows an example of a virtualization layer 1302 located above a physical data center 1304. For the sake of illustration, the virtualization layer 1302 is separated from the physical data center 1304 by a virtual-interface plane 1306. The physical data center 1304 is an example of a distributed computing system. The physical data center 1304 comprises physical objects, including an administration computer system 1308, any of various computers, such as PC 1310, on which a virtual-data-center (“VDC”) management interface may be displayed to system administrators and other users, server computers, such as server computers 1312-1319, data-storage devices, and network devices. Each server computer may have multiple network interface cards (“NICs”) to provide high bandwidth and networking to other server computers and data storage devices. The server computers may be networked together to form server-computer groups within the data center 1304. The example physical data center 1304 includes three server-computer groups each of which have eight server computers. For example, server-computer group 1320 comprises interconnected server computers 1312-1319 that are connected to a mass-storage array 1322. Within each server-computer group, certain server computers are grouped together to form a cluster that provides an aggregate set of resources (i.e., resource pool) to objects in the virtualization layer 1302. Different physical data centers may include many different types of computers, networks, data-storage systems, and devices connected according to many different types of connection topologies.

The virtualization layer 1302 includes virtual objects, such as VMs, applications, and containers, hosted by the server computers in the physical data center 1304. The virtualization layer 1302 may also include a virtual network (not illustrated) of virtual switches, routers, load balancers, and NICs formed from the physical switches, routers, and NICs of the physical data center 1304. Certain server computers host VMs and containers as described above. For example, server computer 1318 hosts two containers identified as Cont₁ and Cont₂; cluster of server computers 1312-1314 host six VMs identified as VM₁, VM₂, VM₃, VM₄, VM₅, and VM₆; server computer 1324 hosts four VMs identified as VM₇, VM₈, VM₉, VM₁₀). Other server computers may host applications as described above with reference to FIG. 4. For example, server computer 1326 hosts an application identified as App₄.

The virtual-interface plane 1306 abstracts the resources of the physical data center 1304 to one or more VDCs comprising the virtual objects and one or more virtual data stores, such as virtual data stores 1328 and 1330. For example, one VDC may comprise the VMs running on server computer 1324 and virtual data store 1328. Automated methods and systems described herein may be executed by an operations manager 1332 in one or more VMs on the administration computer system 1308. The operations manager 1332 provides several interfaces, such as graphical user interfaces, for data center management, system administrators, and application owners. The operations manager 1332 receives streams of metric data from various physical and virtual objects of the data center as described below.

In the following discussion, the term “object” refers to a physical object, such as a server computer and a network device, or to a virtual object, such as an application, VM, virtual network device, or a container. The term “resource” refers to a physical resource of the data center, such as, but are not limited to, a processor, a core, memory, a network connection, network interface, data-storage device, a mass-storage device, a switch, a router, and other any other component of the physical data center 1304. Resources of a server computer and clusters of server computers may form a resource pool for creating virtual resources of a virtual infrastructure used to run virtual objects. The term “resource” may also refer to a virtual resource, which may have been formed from physical resources assigned to a virtual object. For example, a resource may be a virtual processor used by a virtual object formed from one or more cores of a multicore processor, virtual memory formed from a portion of physical memory and a hard drive, virtual storage formed from a sector or image of a hard disk drive, a virtual switch, and a virtual router. Each virtual object uses only the physical resources assigned to the virtual object.

The operations manager 1332 receives information regarding each object of the data center. The object information includes metrics, log messages, properties, events, application traces, and network flows. Methods implemented in the operations manager 1332 find various types of evidence of changes with objects that correspond to performance problems, troubleshoot the performance problems, and generate recommendations for correcting the performance problems. In particular, methods and systems detect performance problems with objects for which no alerts and parameters for detecting the performance problems have been defined or detect a performance problem related to alerts that fail to point to causes of the performance problems.

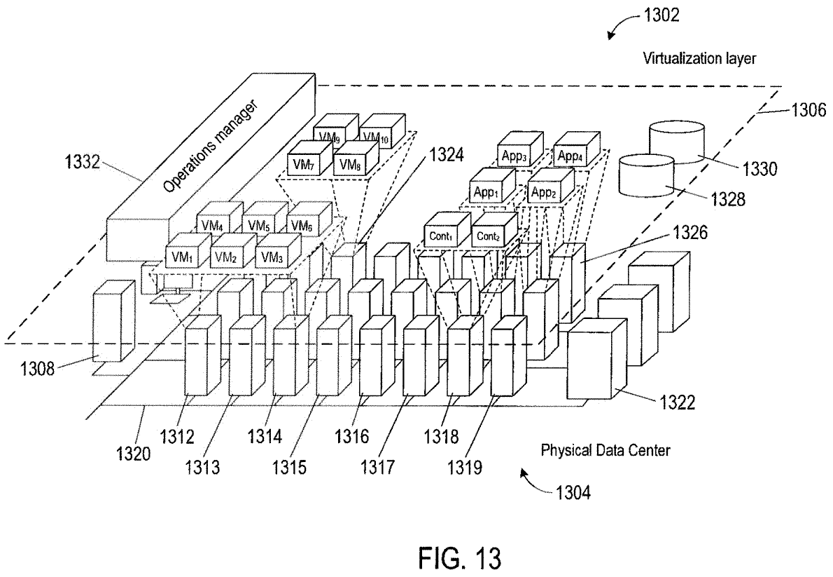

FIGS. 14A-14B show examples of the operations manager 1332 receiving object information from various physical and virtual objects. Directional arrows represent object information sent from physical and virtual resources to the operations manager 1332. In FIG. 14A, the operating systems of PC 1310, server computers 1308 and 1324, and mass-storage array 1322 send object information to the operations manager 1332. A cluster of server computers 1312-1314 send object information to the operations manager 1332. In FIG. 14B, the VMs, containers, applications, and virtual storage may independently send object information to the operations manager 1332. Certain objects may send metrics as the object information is generated while other objects may only send object information at certain times or when requested to send object information by the operations manager 1332. The operations manager 1332 may be implemented in a VM to collect and processes the object information as described below to detect performance problems and may generate recommendations to correct the performance problems or execute remedial measures, such as reconfiguring a virtual network of a VDC or migrating VMs from one server computer to another. For example, remedial measures may include, but are not limited to, powering down server computers, replacing VMs disabled by physical hardware problems and failures, spinning up cloned VMs on additional server computers to ensure that services provided by the VMs are accessible to increasing demand or when one of the VMs becomes compute or data-access bound.

Methods and systems described herein are directed to automating various aspects of troubleshooting a problem in a distributed computing system while utilizing various data sources obtained from monitoring the underlying infrastructure of the facility and applications executing in the facility. The data sources include metrics, log messages, properties, network flows, and traces. An object topology of objects of a data center is determined by parent/child relationships between the objects comprising the set. For example, a server computer is a parent with respect VMs (i.e., children) executing on the host, and, at the same time, the server computer is a child with respect to a cluster (i.e., parent). The object topology may be represented as a graph of objects. The object topology for a set of objects may be dynamically created by the operations manager 1332 subject to continuous updates to VMs and server computers and other changes to the data center.

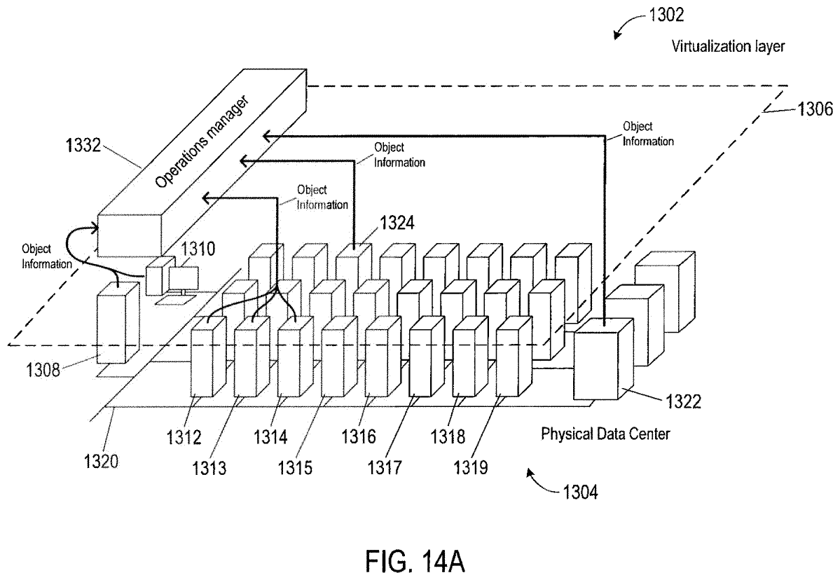

FIG. 15A shows a first example of an object topology for objects of a distributed computing system. In this example, a cluster 1502 comprises four server computers, identified as SC₁, SC₂, SC₃, and SC₄, that are networked together to provide computational and network resources for virtual objects in a virtualization level 1504. The physical resources of the cluster 1502 are aggregated to create virtual resources for the virtual objects in the virtualization layer 1504. The sever computers SC₁, SC₂, SC₃, and SC₄ host virtual objects that include six VMs 1506-1511, three virtual switches 1512-1514, and two datastores 1516-1517. An example server computer, SC₅, host four VMs 1518-1521, a virtual switch 1522, and a data store 1524. In the example object topology of FIG. 15A, the server computers are represented in a first level of the object topology and the virtual objects are represented in a second level of the object topological. The applications, denoted by App₁, App₂, . . . App₁₀, executing in the VMs are represented in a third level of the object topology. The server computers are parents with respect to the virtual objects (i.e., children) and the virtual objects are parents with respect to the applications (i.e., children). FIG. 15B shows a second example of an object topology for the objects shown in FIG. 15A. In this example, the virtual objects are separated into different levels and data center 1526 is represented as a parent of the server computers.

A performance problem with an object of a data center may be related to the behavior of other objects at different levels within an object topology. A performance problem with an object of a data center may be the result of abnormal behavior exhibited by another object at a different level of an object topology of a data center. Alternatively, a performance problem with an object of a data center may create performance problems at other objects located in different levels of the object topology. For example, the applications App₁, App₂, . . . , App₁₀ in FIGS. 15A-15B may be application components of a distributed application that share information. Alternatively, the applications App₁, App₂, . . . , App₆ may be application components of a first distributed application and the applications App₇, App₈, . . . , App₁₀ may be application components of a second distributed application in which the first and second distributed applications share information. When a performance problem arises with an object of the object topology, the performance problem may affect the performance of other objects of the object topology. FIG. 15B shows an example plot of a response time 1528 for App₄. In this example, the response time 1528 exceeds at a response time threshold 1530 at time tₑᵣᵣₒᵣ. In other words, the response time has shifted above the threshold 1530. However, the cause of the increased response time may be due to a performance problem with one or more other objects of the object topology for which no performance problems have been detected.

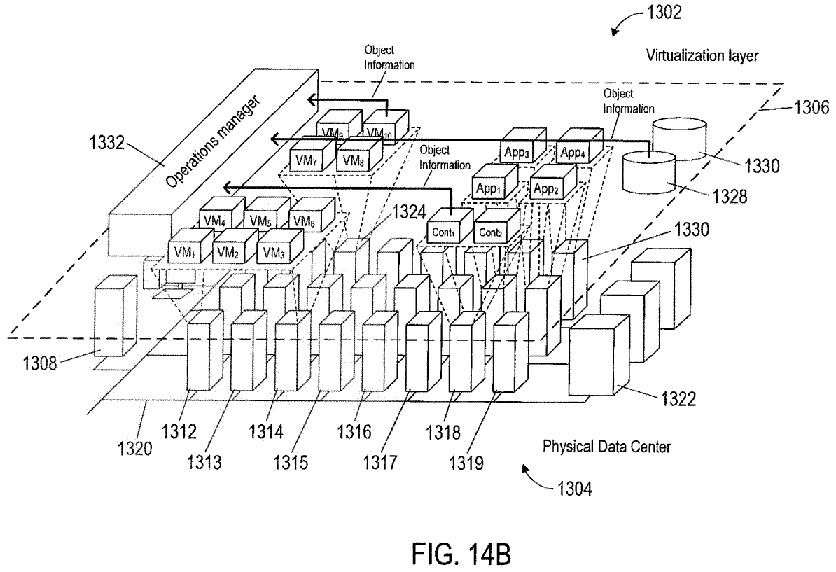

FIG. 16 shows an example of stages of an automated troubleshooting process. Degradation in a distributed computing system or non-optimal performance of an application may originate in either the infrastructure and/or application layers of the system. Automated methods and systems described herein integrate operational information from various system monitoring tools, such as VMware's vRealize Operations, VMware Wavefront, VMware Log Insight, and vRealize Network Insight. The stages include a notification stage 1601 in which notification of an issue is generated in the distributed computing system and/or application. The notification may be an alert generated by any one or more of the system monitoring tools, a phone call, an email, a ticket, or even a hallway conversation. An investigation stage 1602 into the time of the issue, frequency of the issue, change created by the issue, scope of the issue, and history of the issue is carried out. A review stage 1603 reviews the operational information generated by the system monitoring tools, such as metrics, events, log messages, and knowledge based. Root cause analysis stage 1604 analyzes theory and evidence from the operational information to determine a potential root cause and resolution the of the problem. Remediation stage 1605 implements remedial actions and test, documents, and monitors whether the remedial actions resolved the problem.

The automated troubleshooting process described above with reference to FIG. 16 includes the following operations:

1. Unsupervised Learning of “interesting patterns” within an integrated cloud management platform that might be relevant to the issue to be resolved;

2. Detects interesting patterns based on user-defined rules;

3. Automatically queries knowledge base articles based on the discovered interesting patterns, such as a specific log message detected;

4. Discovers relevant time and topology coverage of a problem, such as starting from the issue detection/report time and incrementally going back in time with increasing time horizon and topology coverage until there is no further increase in number of interesting patterns;

5. Trend lining the evolution of the problem in terms of extracted interesting patterns,

their densities across time axis and across topology hierarchies; and

6. Uses supervised learning to predict the problem type experienced in the past using snapshots of interesting patterns.

Interesting patterns cover a large class of patterns and includes user-defined behavioral patterns.

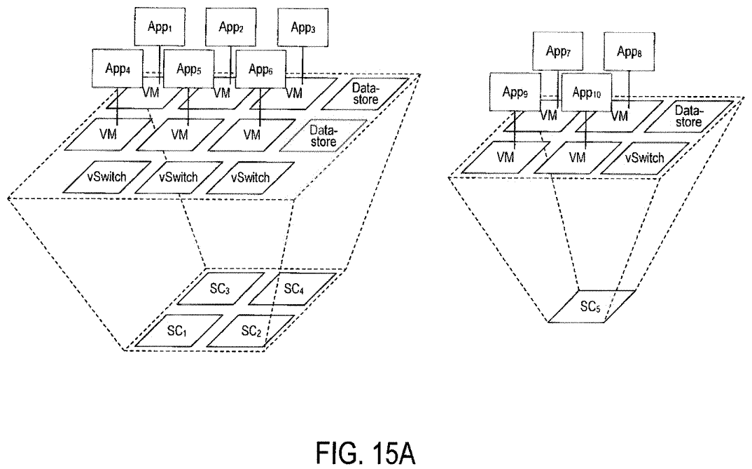

FIG. 17 shows an example automated workflow for troubleshooting problems in a distributed computing system. The workflow represents operations that execute the issue stage 1601 through the review stage 1604 of the troubleshooting process shown in FIG. 16. The workflow may be executed within the operations manager 1332. As shown in FIG. 17, the workflow comprises a measuring layer 1701, a discovery layer 1702, a learning layer 1703, and rank ordering layer 1704. In the measuring layer 1701, the workflow collects object information from objects of an object topology. The object information comprises metrics 1706, events 1707, properties 1708, log messages 1709, traces 1710, and network flows 1711. FIG. 17 also shows the types of information that may be obtained from each type of object information. For example, the metrics 1706 may be provide information regarding performance of an object 1712, capacity of an object 1713, and availability of an object 1714. In the discovery layer 1702, one or more of a problem trigger time 1716, problem time scope 1718, and a problem impact scope 1720 are discovered. A problem trigger time 1716 may be the time when an alert is generated by a system monitoring tool or a point in time when a system administrator or application owner discovers a performance problem with hardware in a distributed computing system or a performance problem with an application or a VM. The problem time scope 1718 may be a time period over which a performance problem is observed. A problem impact scope 1720 may be the effect the performance problem has on other objects of the distributed computing system. Let tₚ be a time when a performance problem is discovered, such as a point in time when an error in execution of an application or object has been detected for a key performance indicator (“KPI”). Examples of a KPI for an application, a VM, or a server computer include average response times, error rates, contention time, or a peak response time. A user may select a problem time scope that encompasses the time tₚ. An example of the time tₚ may be the time, tₑᵣᵣₒᵣ, described above with reference to FIG. 15B and the response time 1528 of the application App₄ is an example of a KPI. In learning layer 1703, automated methods and systems described below may learn interesting patterns in object information. For example, interesting patterns in events 1722 may be revealed by frequency/entropy analysis, sentiment analysis, and criticality of the events. Interesting patterns in configurations 1724 may be revealed by frequency/entropy analysis of configurations. Interesting patterns in metrics, log messages, traces, and network flows (i.e., network flows) 1726 may be revealed by anomaly detection and hypothesis testing. In rank ordering 1704, importance criteria 1728 are determined from the interesting patterns and used to rank order the interesting patterns are described below. Importance criteria 1728 include, but are not limited to, p-value 1731, change magnitude 1732, time proximity 1733, criticality 1734, anomaly degree 1735, sentiment score 1736, and frequency/entropy 1737.

The workflow shown in FIG. 17 may be used in cases of “unknown” problems in a distributed computing system, for which no alerts have been defined or for alerts that do not point out the actual cause of the problem. Whether a system administrator or an application owner troubleshoots an application or an infrastructure problem, the workflow in FIG. 17 automates the important phases/steps in search for potential root causes.

Detection of Interesting Patterns in Metrics, Network Flows, and Properties

### Metrics and Network Flows

As described above with reference to FIGS. 14A-14B, the operations manager 1332 receives numerous streams of time-dependent metric data from objects of the object topology. Each stream of metric data is time series data that may be generated by an operating system, a resource, or by an object itself. A stream of metric data associated with a resource comprises a sequence of time-ordered metric values that are recorded in spaced points in time called “time stamps.” A stream of metric data is simply called a “metric” and is denoted by

v(t)=(xᵢ)ᵢ₌₁^{N}=(x(tᵢ))ᵢ₌₁^{N} (1)

where
v denotes the name of the metric:
N is the number of metric values in the sequence;
xᵢ=x(tᵢ) is a metric value;
tᵢ is a time stamp indicating when the metric value was recorded in a data-storage device; and
subscript i is a time stamp index i=1, . . . , N.

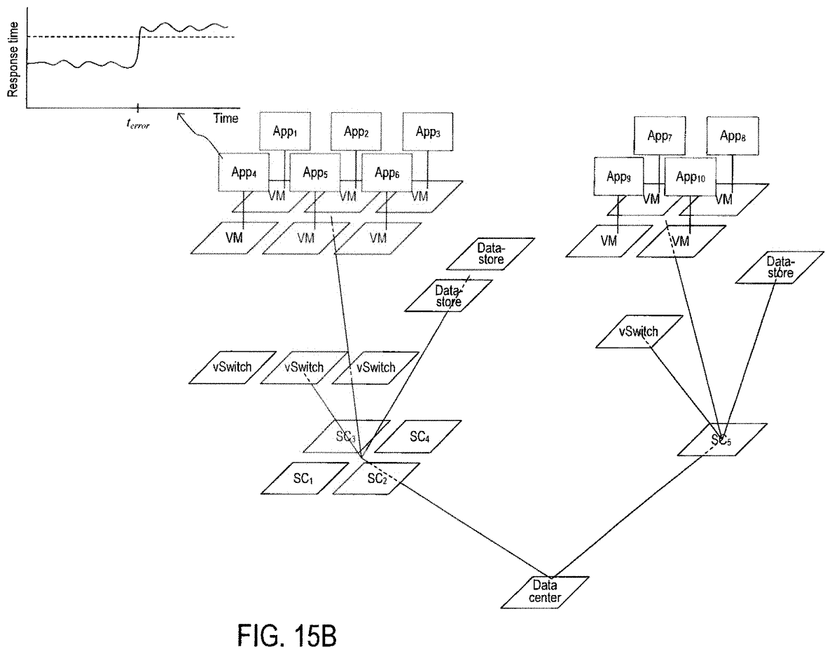

FIG. 18 shows a plot of an example of a metric. Horizontal axis 1802 represents time. Vertical axis 1804 represents a range of metric value amplitudes. Curve 1806 represents a metric as time series data. In practice, a metric comprises a sequence of discrete metric values in which each metric value is recorded in a data-storage device. FIG. 18 includes a magnified view 1808 of three consecutive metric values represented by points. Each point represents an amplitude of the metric at a corresponding time stamp. For example, points 1810-1812 represent consecutive metric values (i.e., amplitudes) xᵢ₋₁, xᵢ, and xᵢ₊₁ recorded in a data-storage device at corresponding time stamps tᵢ₋₁, tᵢ, and tᵢ₊₁. The example metric may represent usage of a physical or virtual resource. For example, the metric may represent CPU usage of a core in a multicore processor of a server computer over time. The metric may represent the amount of virtual memory a VM uses over time. The metric may represent network throughput for a server computer. Network throughput is the number of bits of data transmitted to and from a physical or virtual object and is recorded in megabits, kilobits, or bits per second. The metric may represent network traffic for a server computer. Network traffic at a physical or virtual object is a count of the number of data packets received and sent per unit of time. The metric may also represent object performance, such as CPU contention, response time to requests, and wait time for access to a resource of an object. Network flows, or simply network flows, are metrics used to monitor network traffic flow. Network flows include, but are not limited to, percentage of packets dropped, data transmission rate, data receiver rate, and total throughput.

Methods detect change points in metrics over the troubleshooting time period. A change point may be the result of a performance problem that is active in the problem time scope. Metrics with a single spike or single drop in metric values are not of interest. Instead methods detect changes that have lasted for a longer period of time or are still active. Of particular interest are metrics in which the mean value of metric values has changed over time.

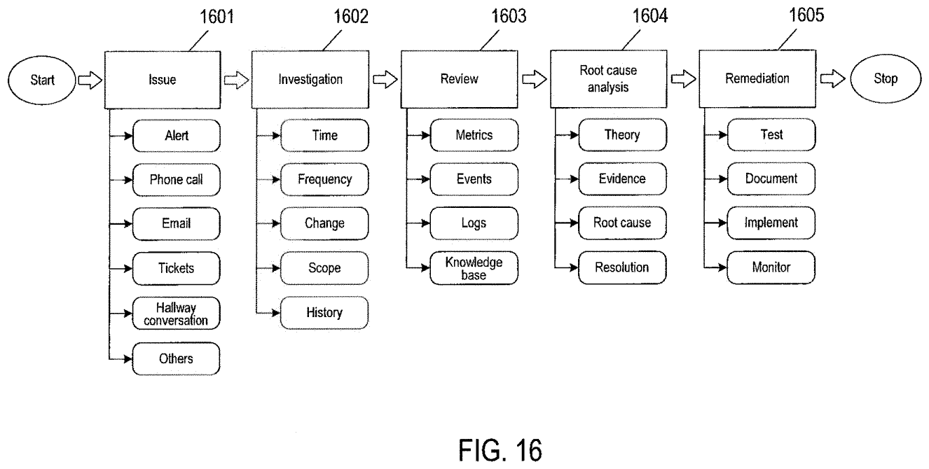

FIG. 19 shows a plot of an example metric in which the mean value of metric has shifted. Curve 1902 represents a metric recorded over time. Prior to time, tᵢₙₜ, metric values are centered around a mean μ_{b}. After the time tᵢₙₜ, metric values are centered around a mean μₐ, which indicates the metric values abruptly changed after time tᵢₙₜ. In other words, the time tᵢₙₜ may be a change point.

In one implementation, a change point may be detected by computing a U statistic for a sliding time window within the longer troubleshooting time period. The sliding time is partitioned into a left-hand window and a right-hand window. The U statistic is separately computed for metric values in the left-hand and right-hand windows and is given by:

$${U}_{t , T} = {\sum }_{i = 1}^{t} {\sum }_{j = t + 1}^{T} {D}_{i j} \\ where \\ {D}_{i j} = s g n ( {x}_{i} - {x}_{j} ) = \{ \begin{matrix}1 & {x}_{i} < {x}_{j} \\ 0 & {x}_{i} = {x}_{j} \\ - 1 & {x}_{i} > {x}_{j}\end{matrix} ; \qquad ( 2 )$$

xᵢ are metric values in the left-hand window;
x₁ are metric values in the right-hand window;
1≤t<T;
t is the largest time value in the left-hand window; and
T is the number of points in the sliding time window.

The value of the U statistic U_{t,T} is calculated based on sign differences between data within the left-hand and right-hand time windows. Note that the U statistic U_{t,T} does not consider the magnitude of the difference between metric values xᵢ and xⱼ. As a result, a single large spike in the left-hand window or the right-hand window does not affect change point detection in the sliding time window.

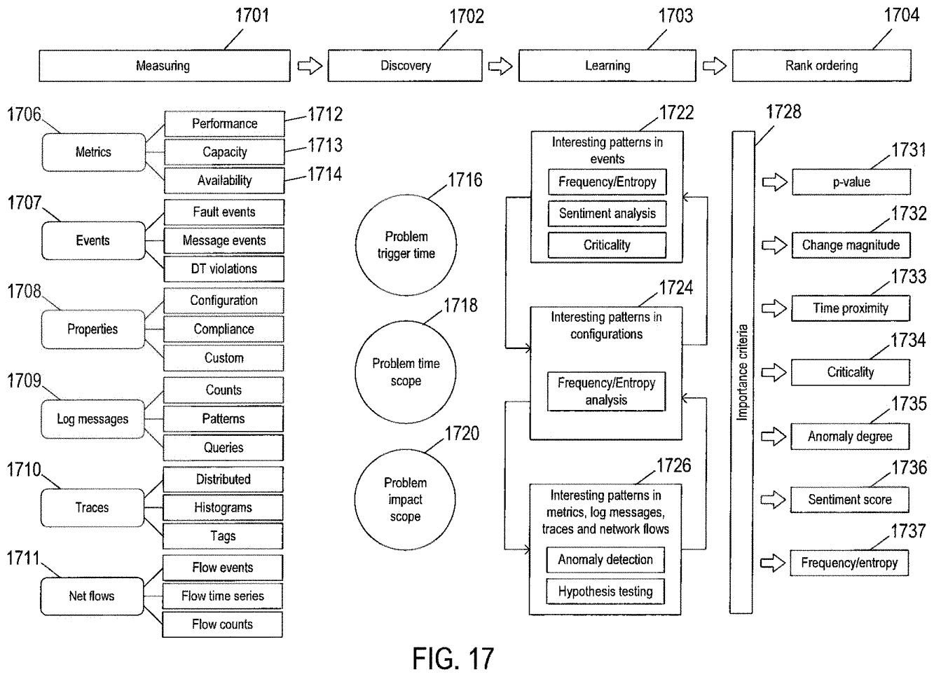

FIG. 20A shows a plot of time-series metric data within a sliding time window. Metric values within the sliding time window are denoted by xᵢ, where i=1, 2, . . . , 8 are indices of metric values in sliding time window. The left-hand window contains the metric values x₁, x₂, x₃, and x₄. The right-hand window contains the metric values x₅, x₆, x₇, and x₈. In this example, the metric time index 4 correspond to tin Equation (2) and index 8 corresponds to T in Equation (2). FIG. 20B shows graphs and the U statistic U_{t,T} computed for metric values in the left-hand and right-hand windows of the sliding time window. FIG. 20B shows graphs with the metric values represented by nodes. Lines between the metric values identify the pair metric values that are used to compute Dᵢⱼ in the U statistic U_{t,T}. For example, graph 2002 represents calculation of the statistic U_{1,8}. Graph 2004 represents calculation of the U statistic U_{4,8} with different line patterns representing different parts of the sum of the U statistic. Graph 2006 represents calculation of the U statistic U_{7,8} with different line patterns representing different parts of the sum of the U statistic.

A non-parametric test statistic for the sliding time window is given by

$${K}_{T} = {max}_{1 \leq t < T} \vert {U}_{t , T} \vert \qquad ( 3 )$$

A p-value of the non-parametric test statistic K_{T} is given by

$$p ≅ 2 exp ( \frac{- 6 {( {K}_{T} )}^{2}}{{T}^{3} + {T}^{2}} ) \qquad ( 4 )$$

A change point at the time, t, is significant when the following condition is satisfied

p<Th_{con} (5)

where Th_{con} is a confidence threshold (e.g., Th_{con}, equals 0.05, 0.04, 0.03, 0.02, or 0.01).

In other words, when the condition in Equation (5) is satisfied, the change in amplitude of the metric values in the left-hand window and the right-hand window is significant.

In another implementation, a permutation test may be applied to the U statistic in the left-hand and right-hand windows. Let the set of U statistics computed for the left-hand window be given by U_{1,T}_{_{L}}, . . . , U_{L,T}_{_{L}}, where 1≤L<T_{L} and T_{L} is the number of points in the left-hand window. Let the set of U statistics computed for the right-hand window be given by U_{1,T}_{_{R}}, . . . , U_{R,T}_{_{R}}, where 1≤R<T_{R} and T_{R} is the number of points in the right-hand window. Note that for the sliding time window T=T_{L}+T_{R}. Let the test statistic be given by

$$Test ( {U}_{1 , {T}_{L}} , … , {U}_{L , {T}_{L}} , {U}_{1 , {T}_{R}} , … , {U}_{R , {T}_{R}} ) = \vert {\overline{U}}_{L , {T}_{L}} - {\overline{U}}_{R , {T}_{R}} \vert$$

$$where$$

$${\overline{U}}_{L , {T}_{L}} = \frac{1}{L} {\sum }_{i = 1}^{L} {U}_{i , {T}_{L}} is the sample mean U statistic for the lef t \text{-} hand window ;$$

$$and$$

$${\overline{U}}_{R , {T}_{R}} = \frac{1}{R} {\sum }_{i = 1}^{R} {U}_{i , {T}_{R}} is the sample mean U statistic for the right \text{-} hand window .$$

Let M=L+R and form M! permutations of the U statistics U_{1,T}, . . . , U_{L,T}_{_{L}}, U_{1,T}, . . . , U_{R,T}_{_{R}}. For each permutation, the test statistic Test is computed. The values for permutations of the test statistic are denoted by Test₁, . . . , Test_{M1}. Under the null hypothesis these values are equally likely. The p-value is given by

$$p = \frac{1}{M !} {\sum }_{j = 1}^{M !} I ( Te s {t}_{j} > {U}_{j , T} )$$

where
T is over the left-hand and right-hand windows; and

$$I ( Te s {t}_{j} > {U}_{j , T} ) = \{ \begin{matrix}1 & for {Test}_{j} > {U}_{j , T} \\ 0 & for {Test}_{j} \leq {U}_{j , T}\end{matrix}$$

If the p-value satisfies the condition in Equation (5), then the distributions of metric values in the left-hand and right-hand windows are different and a change point occurs between the left-hand and right-hand windows.

After a change point has been detected in the sliding time window, the magnitude of the change is computed by

$$Change - Magnitude = \frac{\vert median {( {x}_{i} )}_{L W} - median {( {x}_{i} )}_{R W} \vert}{{max}_{1 \leq i \leq T} ( {x}_{i} ) - {min}_{1 \leq i \leq T} ( {x}_{i} )} \qquad ( 6 )$$

where
median(x₁)_{LW} is the median of the metric values in the left-hand window and
median(x₁)_{RW} is the median of the metric values in the right-hand window.
   The change in metric values within the sliding time window is identified as significant when the change magnitude satisfies the following condition

Change−Magnitude>Th_{mag} (7)

where Th_{mag} is a change magnitude threshold (e.g., Th_{mag}=0.05).

When the condition given by Equation (7) is satisfied, the time, t, of the sliding time window is confirmed as a change point and is denoted by t_{cp}.

In alternative implementations, other change point detection techniques may be used to determine change points in metrics. Other change point detection techniques include likelihood ration methods, probabilistic methods, graph base methods, and clustering methods. For likelihood ratio methods, a statistical formulation of change-point detection analyzes probability distributions of data before and after a candidate change point, and identifies the candidate change point as a change point if the two distributions are significantly different. In these approaches, the logarithm of the likelihood ratio between two consecutive intervals in time-series data is monitored for change points. The probability densities of two consecutive intervals are calculated separately and the ratio of the two probability densities is computed. For probabilistic methods, Bayesian change point detection assumes that a sequence of time series data may be divided into non-overlapping states partitions and the data within each state of time series are identically and independently distributed based on a probability distribution. For graph base methods, a graph may be derived from a distance or a generalized dissimilarity on the sample space, with time series metric values as nodes and edges connecting observations based on their distance. The graph can be defined based on a minimum spanning tree, minimum distance pairing, nearest neighbor graph, or a visibility graph. Graph-based methods are a nonparametric approach that applies a two-sample test on an equivalent graph to determine whether there is a change point at a metric value or not. For clustering methods, the problem of change point detection is considered as a clustering problem with a known or unknown number of clusters. Metric values within clusters are identically distributed and metric values between adjacent clusters are not. If a metric value at a time stamp belongs to a different cluster than the metric value at an adjacent time stamp, then a change point occurs between the two metric values.

Each metric with a change point in the troubleshooting time period may be assigned a rank based on a corresponding p-value and closeness in time of the change point to the point in time tₚ. For example, the rank for metric with a change point in the problem time scope may calculated by

$$\begin{matrix}Rank ( metric ) = {w}_{1} Closeness ( {t}_{c p} ) + {w}_{2} p - value & ( 8 ) \\ where & \\ Closeness ( {t}_{c p} ) = \frac{1}{time - difference ( {t}_{c p} - {t}_{p} )} & ( 9 a )\end{matrix}$$

The parameters w₁ and w₂ in Equation (8) are weights that are used to give more influence to either the closeness or the p-value. For example, the weights may range from 0≤wᵢ≤1, where i=1, 2. In Equation (9a), the closeness of the change point t_{cp} to the time tₚ increases in magnitude the closer the change point t_{cp} is to the time tₚ. In another implementation, it may be desirable to rank metrics with change points t_{cp} that are further away from the time tₚ higher than change points t_{cp} that are closer to the time tₚ as follows:

Closeness(t_{cp})=time−difference(t_{cp}−tₚ) (9b)

A change point in the problem time scope and p-values for the network metrics are computed as described above with reference to Equations (2)-(7). Each network metric may be ranked as follows:

Rank(net_metric)=w₁Closeness(t_{cp})+w₂p−value (10)

where
Closeness(t_{cp}) is the closeness of the change point to the time Tₚₚ (See Equations (9a) and (9b) above); and
p-value is the p-value for the network metric calculated according to Equations (2)-(4).
   The parameters w₁ and w₂ are user assigned weights (e.g., the weights may range from 0≤wᵢ≤1, where i=1, 2). The network metric rank, Rank(net_metric), may be used to indicate the importance of the evidence of a network bottleneck taking place at the object.

Thresholds may be used to monitoring metrics based on confidence-controlled sampling of the metrics over a period of time, such as a day, days, a week, weeks, a month, or a number of months. In one implementation, the thresholds determined from the metric are time-independent thresholds. Time-independent thresholds can be determined for trendy and non-trendy randomly distributed metrics. In another implementation, the thresholds may be time-dependent or dynamic thresholds. Dynamic thresholds can also be determined for trendy and non-trendy periodic monitoring data. Automated methods and systems to determine time-independent thresholds axe described in VS Publication No. 2015/0379110A1, filed Jun. 25, 2014, which is owned by VMware Inc. and is herein incorporated by reference. Methods and systems to determine dynamic thresholds are described in U.S. Pat. No. 10,241,887, which is owned by VMware Inc. and is herein incorporated by reference.

An interesting pattern is identified when one or more metric values violate an upper or lower threshold as follows:

X(tₖ)≥Thᵤₚₚₑᵣ (11a)

where Thᵤₚₚₑᵣ is an upper threshold; and

X(tₖ)≤Th_{lower} (11b)

where Th_{lower} is a lower threshold.

The upper and lower thresholds may be time-independent thresholds. Alternatively, the upper and lower thresholds may be time-independent thresholds. When a threshold is violated, as described above with reference to Equation (11a) or Equation (11b), an alert is generated, indicating that the object has entered an abnormal state.

Property Changes

Automated methods and systems determine evidence of a property change for an object in the problem time scope based on property metrics associated with the object topology. Property change metrics include Boolean metrics and counter metrics. A Boolean metric represents the binary state of an object. The Boolean property metric may represent the ON and OFF state of an object, such as a server computer or a VM, over time. For example, when a server computer shuts down, the state of the server computer switches from ON to OFF which is recorded at a point in time. When the server computer is powered up the state of the server computer switches from OFF to ON which is recorded at a point in time. A counter metric represents a count of operations, such as a count of processes running on an object at point in time or number of responses to client requests executed by an object.

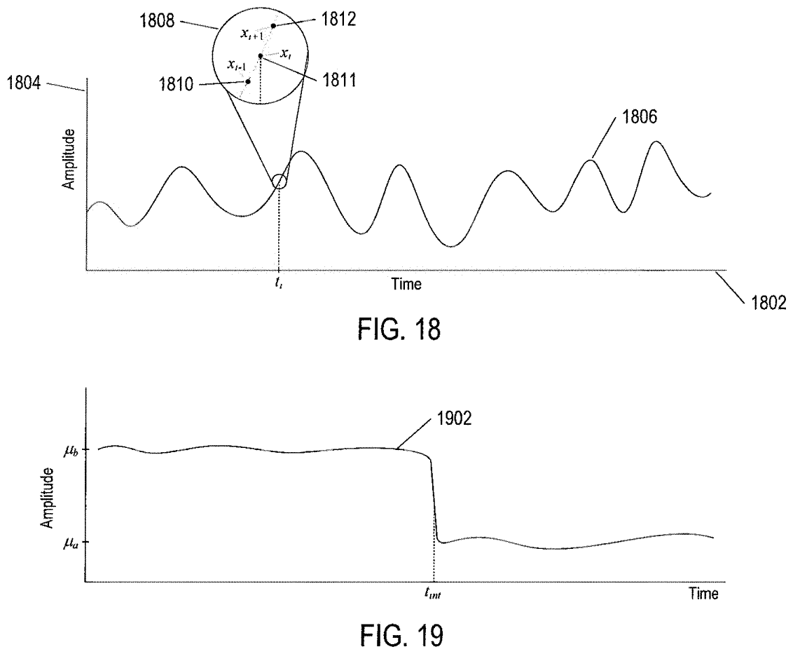

FIG. 21A show an example of a Boolean property metric of an object. Horizontal axis 2102 represents time. Marks along the horizontal axis represents points in time when the ON or OFF state of the object is recorded. Horizontal line 2104 represents the ON state of the object before time tᵢ. Horizontal line 2106 represents the OFF state of the object after time Between the times tᵢ and tⱼ the object switched from ON to OFF.

FIG. 21B show an example of a counter property metric associated with an object. Horizontal axis 2108 represents time. Marks along the horizontal axis represents points in time when a count of the number of operations executed by the object is recorded. Line 2110 represents the number of operations executed by the object before time tᵢ. After time tᵢ the number of operations executed by the object rapidly decreases to zero at time tⱼ and remains at zero.

Methods compute a frequency of a property change in the problem time scope as follows:

$${f}_{change} = \frac{{n}_{c h a n g e}}{{N}_{prop}} \qquad ( 12 )$$

where
n_{change} is the number of times the property of an object changed in the problem time scope (e.g., number of times the objects switched between ON and OFF states); and
Nₚᵣₒₚ is the total number of times the property of the object was recorded in the troubleshooting time period.
   The entropy of the property change in the problem time scope is calculate by

H(f_{change})=g(f_{change}) (13)

A rank of property changes with an object in the problem time scope may be computed by

$$Rank ( prop\_metric ) = {w}_{1} Closeness ( prop\_change ) + {w}_{2} H ( {f}_{change} ) \\ where \\ Closeness ( prop\_change ) = \frac{1}{{n}_{change}} {\sum }_{i = 1}^{{n}_{change}} Closeness ( {t}_{change , i} ) \qquad ( 14 )$$

t_{change,i} is the time of the property change.

The parameters w₁ and w₂ are user assigned weights (e.g., the weights may range from 0≤wᵢ≤1, where i=1, 2). In another implementation, the closeness of one occurrence of a property change in the problem time scope may be given by

$$Closeness ( prop\_change ) = {max}_{i} Closeness ( {t}_{change , i} )$$

The closeness Closeness(t_{change,i}) may be calculated as described above with reference to Equations (9a) and (9b). The rank property change, Rank(prop_change), may be used to indicate the importance of the evidence of property changes taking place at the object.

Anomaly Score

Methods and systems compare a run-time threshold violation compared with historical threshold violations to determine the degree of deviation of metrics from historical behavior. The larger the deviation from historical behavior, the greater the probability that the threshold violation is an interesting pattern. Automated methods and systems include calculation of an anomaly score for each metric with a threshold violation in a run-time period. An anomaly score indicates whether a run-time violation of a corresponding time-dependent, or time-independent, threshold rises to the level of an interesting pattern that is worthy of attention based on a historical anomaly score.

An anomaly score comprises two dimensions of abnormality: 1) duration of a threshold violation (i.e., alert duration) and 2) average distance of metric values from a threshold for the duration of the threshold violation. A historical anomaly score is a two-component vector denoted by G(τ₀, d₀), where τ₀ is the historical average duration of alerts over a historical time period and d₀ is the historical average distance of metric values from the threshold for the durations of the threshold violation (i.e., alerts durations) in the historical time period. When a run-time threshold violation occurs, the duration and averaged distance of metric values from the threshold are used to form a run-time normally score denoted by G(τᵣᵤₙ, dᵣᵤₙ). The components of a run-time normalcy score are compared against the components of the historical normalcy score. If both components the run-time normalcy score are greater than corresponding components of the historical normalcy score (i.e., τᵣᵤₙ≥τ₀ and dᵣᵤₙ≥d₀), then the run-time threshold violation is an interesting pattern. If only one component of a run-time normalcy score is greater than a corresponding component of the historical normalcy score (i.e., τᵣᵤₙ≥τ₀ or dᵣᵤₙ≥d₀), then the run-time threshold violation may be considered an interesting pattern. For example, when τᵣᵤₙ≥τ₀ and dᵣᵤₙ<d₀, the run-time duration is atypical and may be considered an interesting pattern. Alternatively, when τᵣᵤₙ<τ₀ and dᵣᵤₙ≥d₀, the run-time average distance is atypical and may be considered an interesting pattern. If both components the run-time normalcy score are less than corresponding components of the historical normalcy score (i.e., τᵣᵤₙ<τ₀ and dᵣᵤₙ<d₀), then the run-time threshold violation is not an interesting pattern.

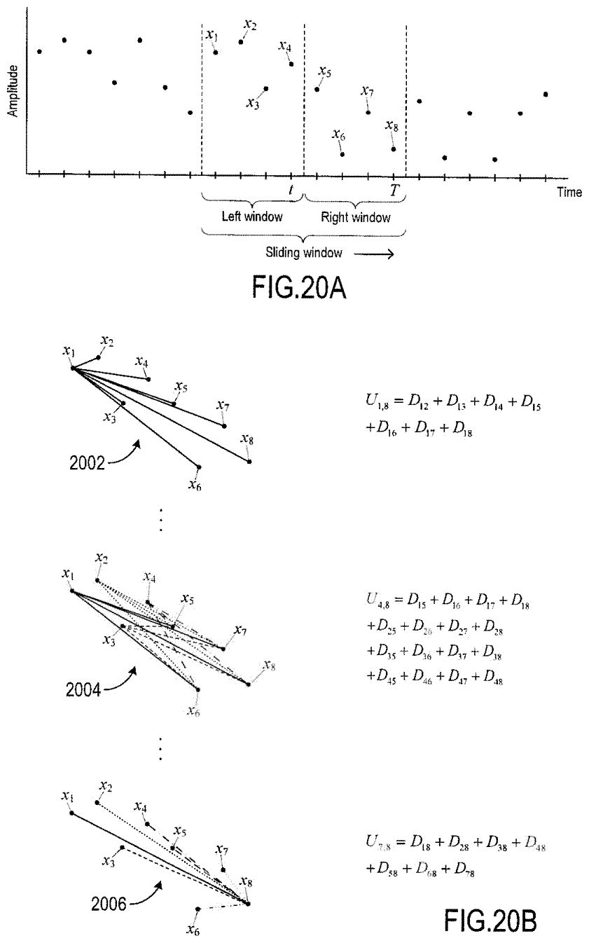

FIG. 22A shows an example plot of a metric over a time period partitioned into a historical time period and a run-time period. Horizontal axis 2202 represents a time axis. Vertical axis 2204 represents a range of values for the metric. Curve 2206 represents the metric. Dashed line 2208 represents a time-dependent, or time-independent, threshold. In this example, the metric exhibits four threshold violations 2210-2213 that correspond to alerts in the historical time period. The durations of the alerts are denoted by τ₁, τ₂, τ₃, and τ₄. The average distances of the metric values from the threshold 2208 in each of the durations τ₁, τ₂, τ₃, and τ₄ are denoted by d₁, d₂, d₃, and d₄, respectively. The metric also exhibits a run-time threshold violation 2214. The duration of the run-time violation is denoted by τᵣᵤₙ and the average of the metric values over the threshold 2208 during the duration τᵣᵤₙ is denoted by dᵣᵤₙ.

FIG. 22B shows an example plot of the two dimensions of abnormality and corresponding abnormality scores for the threshold violation shown in FIG. 22A. Horizontal axis 2216 represents time duration of threshold violations. Vertical axis 2218 represents distance above the threshold. Horizontal dashed line 2220 represents the historical average distance d₀ of metric values from the threshold for alerts in the historical time period. Vertical dashed line 2222 represents the historical average duration of alerts over a historical time period τ₀. Dashed lines 2220 and 2222 divide the abnormality scores into four quadrants. Quadrant 2224 corresponds to normalcy scores that are less than the components of the historical normalcy score. Quadrant 2226 corresponds to normalcy scores that are greater than the components of the historical normalcy score. Quadrants 2228 and 2230 correspond to normalcy scores where one component of a normalcy score is greater than a corresponding component of the historical normalcy score. Solid points represent normalcy scores for the threshold violations 2210-2213 in the historical time period of FIG. 22A. Open circle 2232 represents the normalcy score for the threshold violation 2214 in FIG. 22A. Run-time normalcy scores in the quadrant 2224 correspond to threshold violations that are not interesting patterns. Run-time normalcy scores in the quadrants 2228 and 2230 correspond to threshold violations that may be interesting patterns. Run-time normalcy scores in the quadrant 2226 correspond to threshold violations that are interesting patterns.

### Detection of Interesting Patterns in Events, Log Event Types, and Event Correlations

Log Event Types

Automated methods and systems identify interesting patterns associated with performance problems in log messages generated by objects of an object topology over the problem time scope. A log message is an unstructured or semi-structured time-stamped message that records information about the state of an operating system, state of an application, state of a service, or state of computer hardware at a point in time and is recorded in a log file. Most log messages record benign events, such as input/output operations, client requests, logins, logouts, and statistical information about the execution of applications, operating systems, computer systems, and other devices of a data center. For example, a web server executing on a computer system generates a stream of log messages, each of which describes a date and time of a client request, web address requested by the client, and IP address of the client. Other log messages, on the other hand, record diagnostic information, such as alarms, warnings, errors, or emergencies.

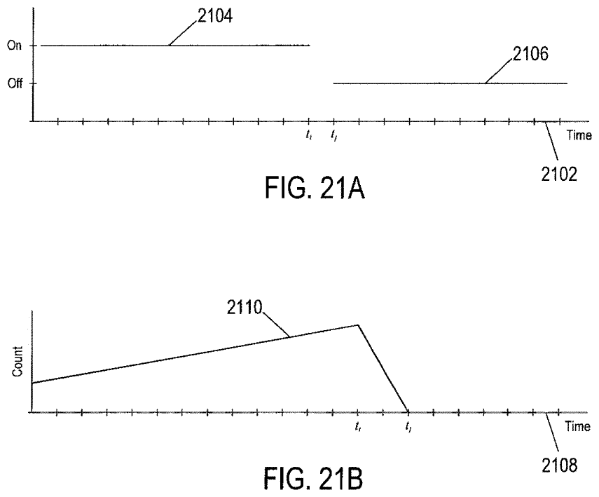

FIG. 23 shows an example of logging log messages in log files. In FIG. 23, computer systems 2302-2306 within a data center are linked together by an electronic communications medium 2308 and additionally linked through a communications bridge router 2310 to an administration computer system 2312 that includes an administrative console 2314 and executes a log management server. For example, the administration computer system 2312 may be the server computer 1308 in FIG. 13 and the log management server may be part of the operations manager 1332. Each of the computer systems 2302-2306 may run a log monitoring agent that forwards log messages to the log management server executing on the administration computer system 2312. As indicated by curved arrows, such as curved arrow 2316, multiple components within each of the discrete computer systems 2302-2306 as well as the communications bridge/router 2310 generate log messages that are forwarded to the log management server. Log messages may be generated by any event source. Event sources may be, but are not limited to, application programs, operating systems, VMs, guest operating systems, containers, network devices, machine codes, event channels, and other computer programs or processes running on the computer systems 2302-2306, the bridge; router 2310 and any other components of a distributed computing system. Log messages may be received by log monitoring agents at various hierarchical levels within a discrete computer system and then forwarded to the log management server. The log messages are recorded in a data-storage device or appliance 2318 as log files 2320-2324. Rectangles, such as rectangle 2326, represent individual log messages. For example, log file 2320 may contain a list of log messages generated within the computer system 2302. Each log monitoring agent has a configuration that includes a log path and a log parser. The log path specifies a unique file system path in terms of a directory tree hierarchy that identifies the storage location of a log file on the administration computer system 2312 or the data-storage device 2318. The log monitoring agent receives specific file and event channel log paths to monitor log files and the log parser includes log parsing rules to extract and format lines of the log message into log message fields described below. Each log monitoring agent sends a constructed structured log message to the log management server. The administration computer system 2312 and computer systems 2302-2306 may function without log monitoring agents and a log management server, but with less precision and certainty.

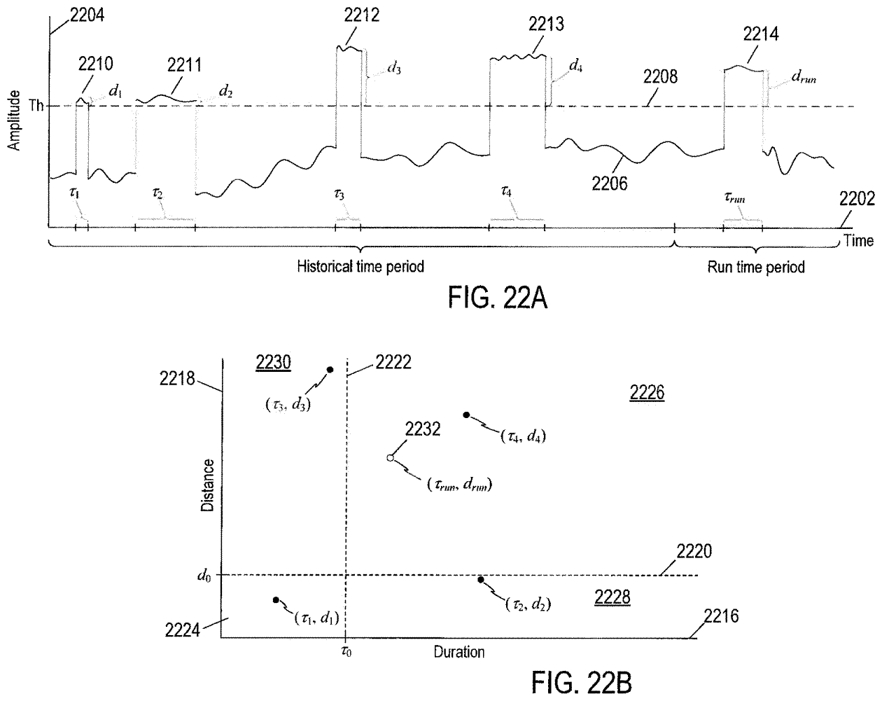

FIG. 24 shows an example source code 2402 of an event source, such as an application, an operating system, a VM, a guest operating system, or any other computer program or machine code that generates log messages. The source code 2402 is just one example of an event source that generates log messages. Rectangles, such as rectangle 2404, represent a definition, a comment, a statement, or a computer instruction that expresses some action to be executed by a computer. The source code 2402 includes log write instructions that generate log messages when certain events predetermined by a developer occur during execution of the source code 2402. For example, source code 2402 includes an example log write instruction 2406 that when executed generates a “log message 1” represented by rectangle 2408, and a second example log write instruction 2410 that when executed generates “log message 2” represented by rectangle 2412. In the example of FIG. 24, the log write instruction 2408 is embedded within a set of computer instructions that are repeatedly executed in a loop 2414. As shown in FIG. 24, the same log message 1 is repeatedly generated 2416. The same type of log write instructions may also be in different places throughout the source code, which in turns creates repeats of essentially the same type of log message in the log file.

In FIG. 24, the notation “log.write( )” is a general representation of a log write instruction. In practice, the form of the log write instruction varies for different programming languages. In general, log messages are relatively cryptic, including generally only one or two natural-language words and/or phrases as well as various types of text strings that represent file names, path names, and, perhaps various alphanumeric parameters that may identify objects, such as VMs, containers, or virtual network interfaces. In practice, a log write instruction may also include the name of the source of the log message (e.g., name of the application program, operating system and version, server computer, and network device) and the name of the log file to which the log message is recorded. Log write instructions may be written in a source code by the developer of an application program or operating system in order to record events that occur while an operating system or application program is executing. For example, a developer may include log write instructions that record events including, but are not limited to, information identifying startups, shutdowns, I/O operations of applications or devices; errors identifying runtime deviations from normal behavior or unexpected conditions of applications or non-responsive devices; fatal events identifying severe conditions that cause premature termination; and warnings that indicate undesirable or unexpected behaviors that do not rise to the level of errors or fatal events. Problem-related log messages (i.e., log messages indicative of a problem) can be warning log messages, error log messages, and fatal log messages. Informative log messages are indicative of a normal or benign state of an event source.

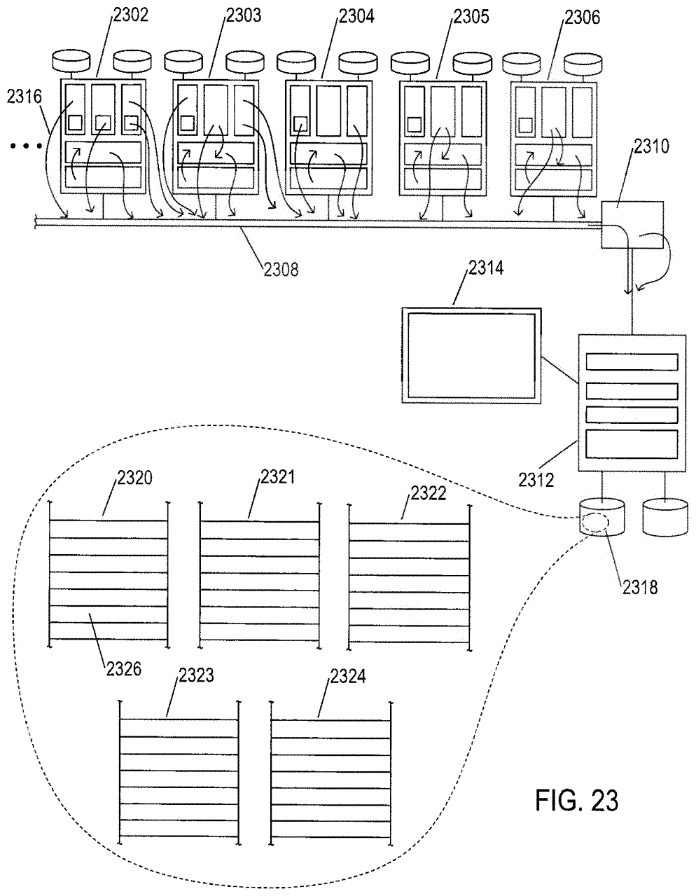

FIG. 25 shows an example of a log write instruction 2502. In the example of FIG. 25, the log write instruction 2502 includes arguments identified with “$.” For example, the log write instruction 2502 includes a time-stamp argument 2504, a thread number argument 2505, and an internet protocol (“IP”) address argument 2506. The example log write instruction 2502 also includes text strings and natural-language words and phrases that identify the type of event that triggered the log write instruction, such as “Repair session” 2508. The text strings between brackets “[ ]” represent file-system paths, such as path 2510. When the log write instruction 2502 is executed by a log management agent, parameters are assigned to the arguments and the text strings and natural-language words and phrases are stored as a log message of a log file.

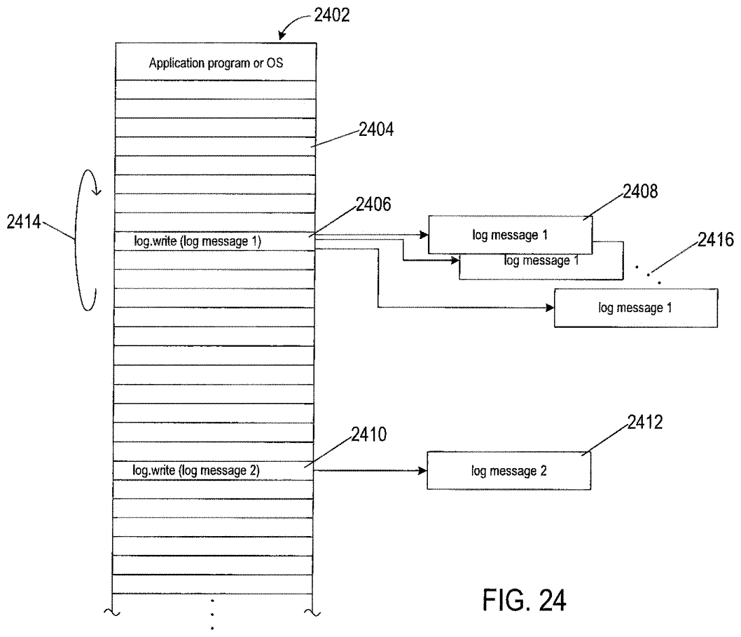

FIG. 26 shows an example of a log message 2602 generated by the log write instruction 2502. The arguments of the log write instruction 2502 may be assigned numerical parameters that are recorded in the log message 2602 at the time the log message is written to the log file. For example, the time stamp 2504, thread 2505, and IP address 2506 arguments of the log write instruction 2502 are assigned corresponding numerical parameters 2604-2606 in the log message 2602. The time stamp 2604 represents the date and time the log message is generated. The text strings and natural-language words and phrases of the log write instruction 2502 also appear unchanged in the log message 2302 and may be used to identify the type of event (e.g., informative, warning, error, or fatal) that occurred during execution of the event source.

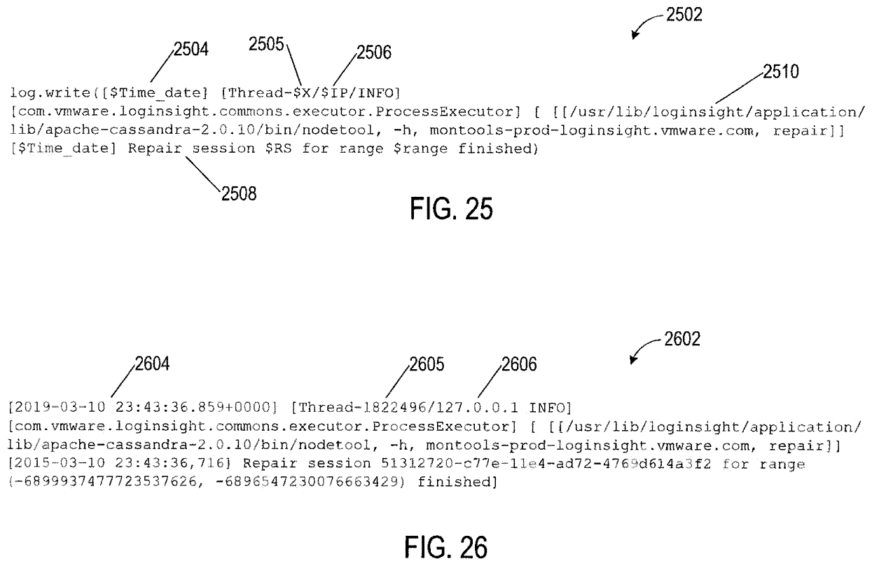

As log messages are received from various event sources, the log messages are stored in corresponding log files in the order in which the log messages are received. FIG. 27 shows an example of eight log message entries of a log file 2702. In FIG. 27, each rectangular cell, such as rectangular cell 2704, of the portion of the log file 2702 represents a single stored log message. For example, log message 2702 includes a short natural-language phrase 2706, date 2708 and time 2710 numerical parameters, and an alphanumeric parameter 2712 that appears to identify a host computer.

Automated methods and systems perform event analysis on each log message generated in the problem time scope. Event analysis discards stop words, numbers, alphanumeric sequences, and other information from the log message that is not helpful to determining the event described in the log message, leaving plaintext words called “relevant tokens” that may be used to determine the state of the object.

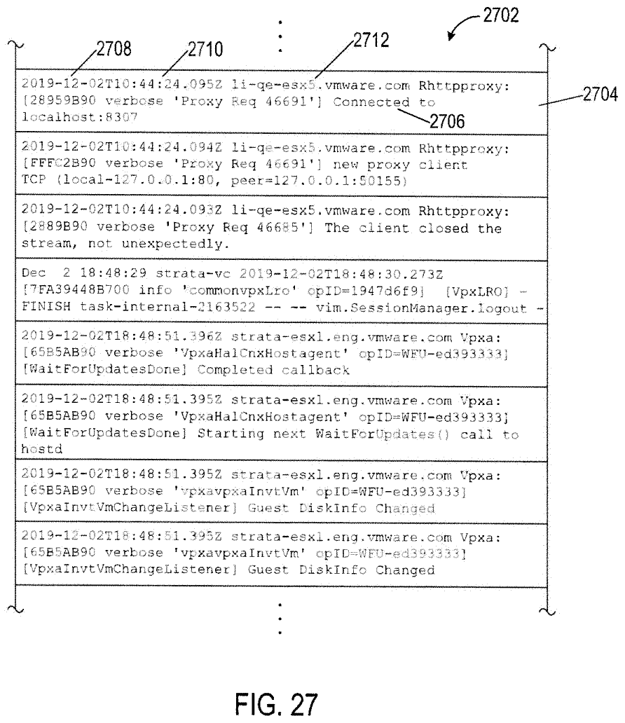

FIG. 28 shows an example of event analysis performed on an example error log message 2800. The error log message 2800 is tokenized by considering the log message as comprising tokens separated by non-printed characters, referred to as “white spaces.” Tokenization of the error log message 2800 is illustrated by underlining of the printed or visible tokens comprising characters. For example, the date 2802, time 2803, and thread 2804 of the header are underlined. Next, a token-recognition pass is made to identify stop words and parameters. Stop words are common words, such as “they,” “are,” “do,” etc. do carry any useful information. Parameters are tokens or message fields that are likely to be highly variable over a set of messages of a particular type, such as date/time stamps. Additional examples of parameters include global unique identifiers (“GUIDs”), hypertext transfer protocol status values (“HTTP statuses”), universal resource locators (“URLs”), network addresses, and other types of common information entities that identify variable aspects of an event. Stop words and parametric tokens are indicated by shading, such as shaded rectangle 2806, 2807, and 2808. Stop words and parametric tokens are discarded leaving the non-parametric text strings, natural language words and phrases, punctuation, parentheses, and brackets. Various types of symbolically encoded values, including dates, times, machine addresses, network addresses, and other such parameters can be recognized using regular expressions or programmatically. For example, there are numerous ways to represent dates. A program or a set of regular expressions can be used to recognize symbolically encoded dates in any of the common formats. It is possible that the token-recognition process may incorrectly determine that an arbitrary alphanumeric string represents some type of symbolically encoded parameter when, in fact, the alphanumeric string only coincidentally has a form that can be interpreted to be a parameter. Methods and systems do not depend on absolute precision and reliability of the event-message-preparation process. Occasional misinterpretations do not result in mischaracterizing log messages. The log message 2800 is subject to textualization in which an additional token-recognition step of the non-parametric portions of the log message is performed in order to discard punctuation and separation symbols, such as parentheses and brackets, commas, and dashes that occur as separate tokens or that occur at the leading and trailing extremities of previously recognized non-parametric tokens. Uppercase letters are converted to lowercase letters. For example, letters of the word “ERROR” 2810 may converted to “error.” Alphanumeric words 2812 and 2814, such as interface names and universal unique identifiers, are discarded, leaving plaintext relevant tokens 2816.

The plaintext relevant tokens may be used to classify the log messages as error, warning, or information log messages. Methods determine trends in error, warning, and information log messages generated within the problem time scope. Relative frequencies of error messages may be computed in time intervals, or time bins, of the problem time scope as follows:

$$\begin{matrix}R {F}_{e r r} = \frac{n ( e v e n {t}_{err} )}{{N}_{i n t}} & ( 15 a ) \\ {RF}_{warn} = \frac{n ( e v e n {t}_{warn} )}{{N}_{i n t}} & ( 15 b ) \\ and & \\ R {F}_{info} = \frac{n ( even {t}_{info} )}{{N}_{int}} & ( 15 c )\end{matrix}$$

where
Nᵢₙₜ is the number of log messages generated in a time interval (tᵢ, tᵢ₊₁];
n(etₑᵣᵣ) is the number error log messages generated in the interval (tᵢ, tᵢ₊₁];
n(et_{warn}) is the number warning log messages generated in the interval (tᵢ, tᵢ₊₁]; and)
n(et_{info}) is the number informational log messages generated in the interval (tᵢ, tᵢ₊₁].

FIG. 9 shows a plot of examples of trends in error, warning, and informational log messages. Suppose time t₀ represents the beginning of the problem time scope and time t₄ represents the end of the problem time scope. Bars represent relative frequencies of error, warning, and informational log messages generated by objects of the object topology within time intervals (tᵢ, tᵢ₊₁], where 1=1, 2, 3, 4. For example, bars 2901-2903 represent relative frequencies of error, warning, and informational log messages with time stamps in time interval (t₀, t₁]. In this example, dashed line 2904 and dotted line 2906 reveal that corresponding error and warning log messages are increasing with time. By contrast, dot-dashed line 2908 reveals that information log message are decreasing over the same period of time.

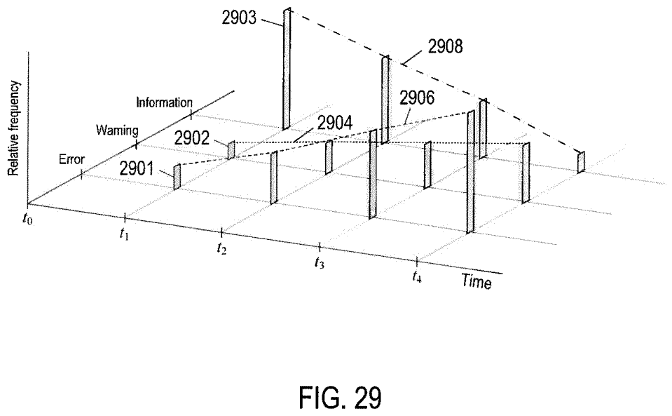

Methods include detecting a change in event-type distributions for the left-hand and right-hand time windows of the sliding time window applied to the problem time scope. FIG. 30A shows a time axis 3001 with a time tₐ that partitions a sliding time window into left-hand time window 3002 defined by tᵢ≤t<tₐ, where tᵢ is a time less than the time tₐ and right-hand time window 3003 defined by tₐ<t≤t_{f}, where t_{f} is a time greater than the time tₐ. For example, the time tₐ may be assigned the change point t_{cp} in Equation (2) above. The durations of the left-hand and right-hand time windows may be equal (i.e., tₐ−tᵢ=t_{f}−tₐ). FIG. 30A also shows a portion of a log file 3004 with event messages generated by objects of the object topology. Rectangles 3005 represent log messages recorded in the log file 3004 with time stamps in the left-hand time window 3002. Rectangles 3006 represent log messages recorded in the log file 3004 with time stamps in the right-hand time window 3003.

In other implementations, rather than considering log messages generated within corresponding left-hand and right-hand time windows, fixed numbers of log messages that are generated closest to the time tₐ may be considered. FIG. 30B shows obtaining fixed numbers of log messages recorded before and after time tₐ, where N is the number of log messages recorded with time stamps that precede the time tₐ and N′ is the number of log messages with time stamps that follow the time tₐ. In certain embodiments, the fixed numbers N and N′ may be equal.

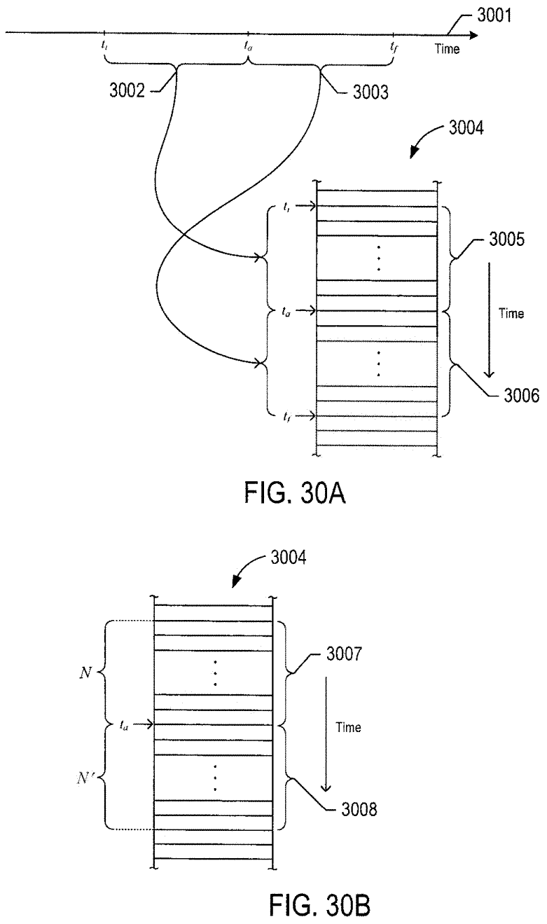

FIG. 31 shows event-type logs obtained from corresponding left-hand and right-hand time windows recorded in the log file 3104. In block 3102, event analysis is applied to each log message of the log messages 3104 recorded before (i.e., pre-log messages) the time tₐ in order to determine the event type of each log message in the log messages 3104. In block 3106, event analysis is also applied to each log message of log messages 3108 recorded after (i.e., post-log messages) time tₐ in order to determine the event type of each log message in the log messages 2808. The log messages 3104 and 3108 may be obtained as described above with reference to FIGS. 30A-30B. Event analysis applied in blocks 3102 and 3106 to the log messages 3104 and 3108 reduces the log messages to text strings and natural-language words and phrases (i.e., non-parametric tokens). In block 3110, relative frequencies of the event types of the log messages 3104 are computed. For each event type of the log messages 3104, the relative frequency is given by

$$R {F}_{k}^{pre} = \frac{{n}_{pre} ( e {t}_{k} )}{{N}_{p r e}} \qquad ( 16 a )$$

where
nₚᵣₑ(etₖ) is the number of times the event type etₖ appears in the pre-alert log messages; and
Nₚᵣₑ is the total number of log messages 2804.
   An event-type log 3112 is formed from the different event types and associated relative frequencies. In block 3118, relative frequencies of the event types of the log messages 3108 are computed. For each event type of the messages 3108, the relative frequency is given by

$$R {F}_{k}^{post} = \frac{{n}_{p o s t} ( e {t}_{k} )}{{N}_{post}} \qquad ( 16 b )$$

where
nₚₒₛₜ(etₖ) is the number of times the event type etₖ appears in the post-alert log messages; and
Nₚₒₛₜ is the total number of post-alert log messages.
   An event-type log 3120 is formed from the different event types and associated relative frequencies.

FIG. 31 shows a histogram 3126 of a pre-time tₐ event type distribution and a histogram 3128 of a post-time tₐ event type distribution. Horizontal axes 3130 and 3132 represent the event types. Vertical axes 3134 and 3136 represent relative frequency ranges. Shaded bars represent the relative frequency of each event type. In the example, of FIG. 31, the pre-time tₐ event type distribution 3126 and the post-time tₐ event type distribution 3128 display differences in the relative frequencies of certain event types both before and after the time tₐ the relative frequencies of other event types appear unchanged before and after the alert. For example, the relative frequency of the event type et₁ did not change before and after the time tₐ. By contrast, the relative frequencies of the event types et₄ and et₆ increased significantly after the time tₐ, which may an indication of a performance problem.

Methods compute a similarity between pre-time tₐ event-type distribution and the post-time tₐ event-type distribution. The similarity provides a quantitative measure of a change to the object associated with the log messages. The similarity indicates how much the relative frequencies of the event types in the pre-time tₐ event-type distribution differ from the same event types of the post-time tₐ event-type distribution.

In one implementation, a similarity may be computed using the Jensen-Shannon divergence between the pre-alert event type distribution and the post-alert event type distribution:

$$S i {m}_{JS} ( {t}_{a} ) = - {\sum }_{k = 1}^{K} {M}_{k} log {M}_{k} + \frac{1}{2} [ {\sum }_{k = 1}^{K} {P}_{k} log {P}_{k} + {\sum }_{k = 1}^{K} {Q}_{k} log {Q}_{k} ] \qquad ( 17 )$$

where
Pₖ=RFₖ^{pre}
Qₖ=RFₖ^{post}; and
Mₖ=(Pₖ+Qₖ)/2.
   In another implementation, the similarity may be computed using an inverse cosine as follows:

$$S i {m}_{CS} ( {t}_{a} ) = 1 - \frac{2}{π} {cos}^{- 1} [ \frac{{\sum }_{k = 1}^{K} {P}_{k} {Q}_{k}}{\sqrt{{\sum }_{k = 1}^{K} {( {P}_{k} )}^{2}} \sqrt{{\sum }_{k = 1}^{K} {( {Q}_{k} )}^{2}}} ] \qquad ( 18 )$$

The similarity is a normalized value in the interval [0,1] that may be used to measure how much, or to what degree, the pre-time tₐ event-type distribution differs from the post-time tₐ event-type distribution. The closer the similarity is to zero, the closer the pre-time tₐ event-type distribution and the post-time tₐ event-type distribution are to one another. For example, when Sim_{JS}(tₐ)=0, the pre-time tₐ event-type distribution and the post-time tₐ event-type distribution are identical. On the other hand, the closer the similarity is to one, the farther the pre-time tₐ event-type distribution and the post-time tₐ event-type distribution are from one another. For example, when Sim_{JS}(tₐ)=1, the pre-time tₐ event-type distribution and the post-time tₐ event-type distribution are as far apart from one another as possible.

The time tₐ may be identified as a change point when the following condition is satisfied

0<Thₛᵢₘ≤Sim(tₐ)≤1 (19)

where
Thₛᵢₘ is a similarity threshold; and
Sim(tₐ) is Sim_{JS}(tₐ) or Sim_{CS}(tₐ).
   In other embodiments, deviations from a baseline event-type distribution may be used to compute the change point as described U.S. Pat. No. 10,509,712, which is owned by VMware, Inc. and is herein incorporated by reference.

The log messages generated after the change point tₐ in the problem time scope may be ranked based on the similarity and closeness in time of the change point tₐ to the point in time tₚ. For example, the rank of an object in the object topology may be calculated by

Rank(Object)=w₁Closeness(tₐ)+w₂Sim(tₐ) (20)

The Closeness(tₐ) may be calculated using Equation (9a) or Equation (9b) described above. The parameters w₁ and w₂ in Equation (20) are weights that are used to give more influence to either the closeness or the p-value. For example, the weights may range from 0≤wᵢ≤1, where i=1, 2.

Events

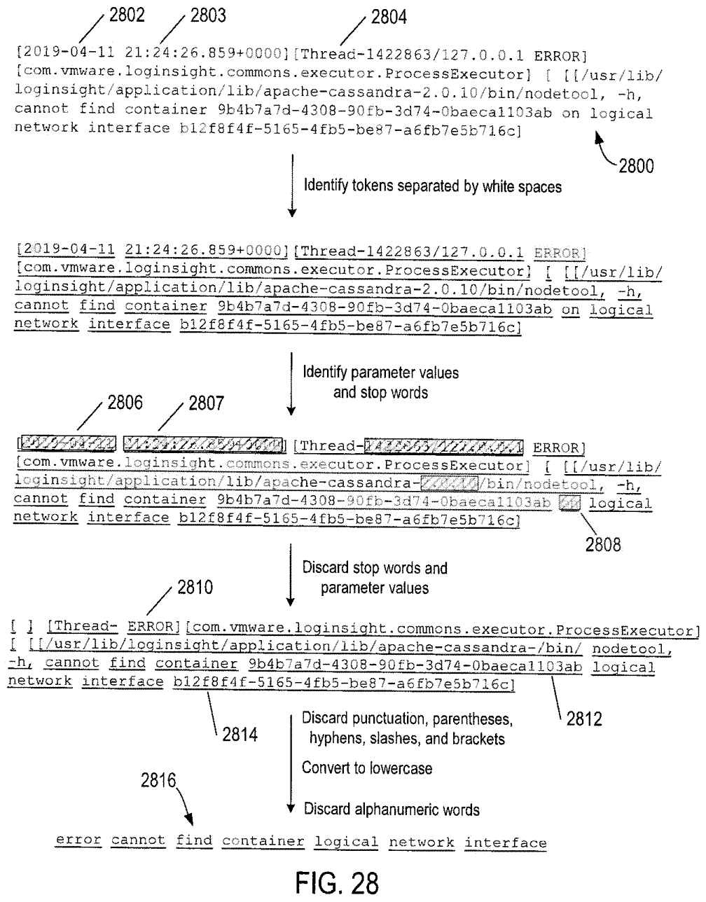

Methods include analyzing events associated with the object topology for interesting patterns in changes associated with adverse events that may have been triggered and remain active during the problem time scope. The adverse events include faults, change events, notifications, and dynamic threshold violations. Dynamic threshold violations occur when metric values of a metric exceed a dynamic threshold. Note that hard threshold violations are excluded from consideration because hard threshold violations are part of alert definitions. Adverse events may be recorded in log messages generated during the problem time scope as described above. Each adverse event may be ranked according to one or more of the following criteria: a sentiment score, criticality score, active or cancelled status of the event, closeness in time to the point in time Tₚₚ, frequency of the event in the problem time scope, and entropy of the event. Calculation of the sentiment score and the criticality score is described below with reference to FIG. 29.

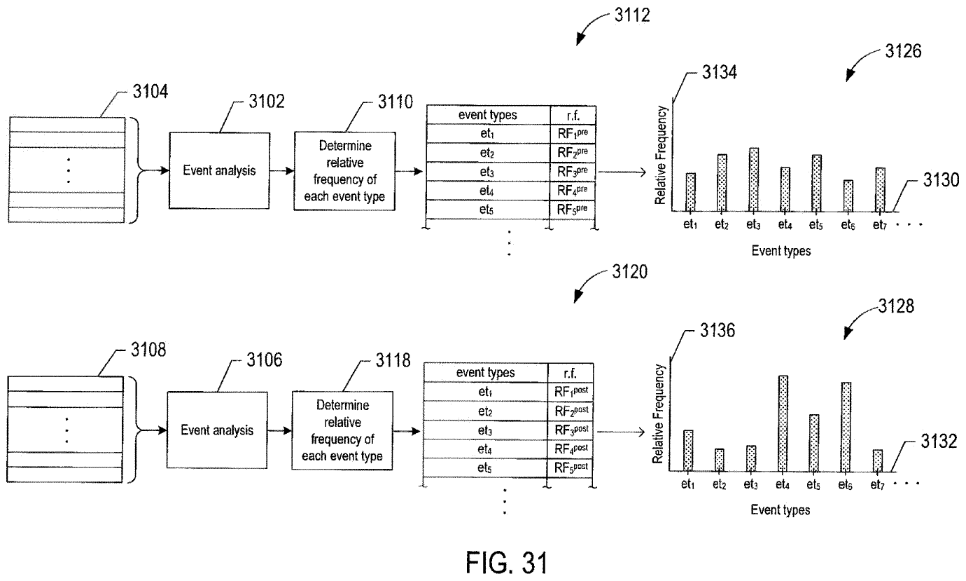

FIG. 32 shows determination of a sentiment score and criticality score for a list of adverse events 3202 recorded in the problem time scope. Each rectangle represents an event entry in the list of events 3202, such as a fault, a change event, a notification, or a dynamic threshold violation of metric, reported to the operations manager 1332 in the problem time scope. Each event has an associated time stamp. For example, entry 3204 may represent metric values of a metric associated with an object that violates a dynamic threshold violation. The metric and time of the dynamic threshold violation are recorded in the entry 3202. Entry 3206 may record an event and time stamp of a log message associated with an object. An average sentiment score may be calculated for each entry in the list of events 3202 using a sentiment score table 3208. The sentiment score table 3208 includes a list of keywords 3210 and a list of associated sentiment scores 3212. For example, suppose event analysis applied to the log message recorded in entry 3206 reveals that the log message contains the plain text words: error, cannot, find, container, logical, network, and interface, as described above with reference to FIG. 28. Suppose these words are assigned the corresponding sentiment scores: 100, 90, 0, 0, 0, 0, and 0. The average sentiment score for the entry 3206 is 95. FIG. 32 also shows a criticality table 3212 that may be used to assign a criticality score to entries in the list of events 3202. For example, if the values of the metrics that violated the dynamic threshold recorded in entry 3204 correspond to a warning, the event recorded in entry 3204 may be assigned a criticality score between 26-50 that depends on how far the metric values are from the dynamic threshold.

The frequency of an adverse event in the problem time scope is given by

$${f}_{e v e n t} = \frac{{n}_{event}}{{N}_{e v e n t}} \qquad ( 21 )$$

where
nₑᵥₑₙₜ is the number of times the same adverse event occurred in the problem time scope; and
Nₑᵥₑₙₜ is the total number of events in the problem time scope.
   The entropy of the adverse event is given by

H(fₑᵥₑₙₜ)=−log(fₑᵥₑₙₜ) (22)

Methods and systems may discard events, such as log messages and notification, that contain positive phrases, such as “completed with status \‘success\’”, “restored,” “succeeded,” and “sync completed.”

A rank for adverse event may be calculated as follows:

Rank(event)=w₁Aveₛₛ(event)+w₂CS(event)+w₃Closeness(event)+w₄H(fₑᵥₑₙₜ)+w₅Status(event) (23)

where
Aveₛₛ(event) is the average sentiment score for the event;

$$Closeness ( event ) = \frac{1}{{n}_{event}} {\sum }_{i = 1}^{{n}_{event}} Closeness ( {t}_{event , i} )$$

t_{event,i} is the time of the i-th occurrence of the event in the problem time scope

CS (event) is the criticality score for the event;

Status(event) represents the status of the event (e.g., Status(event)=1 if the event is active and Status(event)=0 if the event is cancelled.)

In another implementation, the closeness of an event having more than one occurrence in the problem time scope may be given by

Closeness(event)=max Closeness(t_{event,i})

The closeness Closeness(t_{event,i}) may be calculated as described above with reference to Equations (9a) and (9b). The parameters w₁, w₂, w₃, w₄, and w₅ in Equation (23) are weights that are used to give more influence to terms in Equation (23). For example, the weights may range from 0≤wᵢ<1, where i==1, 2, . . . , 5.

Breaking Correlations Between Events

A breakage of correlations between events is an interesting pattern. Metric data values that violate a time dependent, or time independent, threshold is an event. Certain metrics may be associated with metrics that historically exhibit events may be correlated, such as prior to a change point, but at run time these same metrics may no longer be correlated. This change in correlation of metrics associated with events is an interesting pattern. Consider, for example, a set of metrics produced in the distributed computing system:

{v⁽ⁿ⁾(t)}ₙ₌₁^{N}^{ₛ} (24)

where
v⁽ⁿ⁾(t) denotes the n-th stream of metric data given by Equation (1); and
Nₛ is the number of metrics in the set.
   Metrics that are constant or nearly constant are discarded based on the standard deviation of each metric. The standard deviation of each set of metric data is computed as follows:

$${σ}^{( n )} = \sqrt{\frac{1}{N} {\sum }_{i = 1}^{N} {( {x}_{i}^{( n )} - {μ}^{( n )} )}^{2}} \qquad ( 25 a )$$

where the mean is given by

$${μ}^{( n )} = \frac{1}{N} {\sum }_{i = 1}^{N} {x}_{i}^{( n )} \qquad ( 25 b )$$

When the standard deviation σ⁽ⁿ⁾>εₛₜ, where εₛₜ is a standard deviation threshold (e.g., εₛₜ=0.01), the set of metric data v⁽ⁿ⁾(t) is retained. Otherwise, when the standard deviation σ⁽ⁿ⁾≤εₛₜ, the metric v⁽ⁿ⁾(t) is essentially constant and is discarded. The remaining set of non-constant metrics is denoted by {v⁽ⁿ⁾(t)}ₙ₌₁^{N}^{_{nc}}, where N_{nc} is the number of non-constant metrics (i.e., N_{nc}≤Nₛ). Time synchronization is performed in order to time synchronize the remaining non-constant metrics.

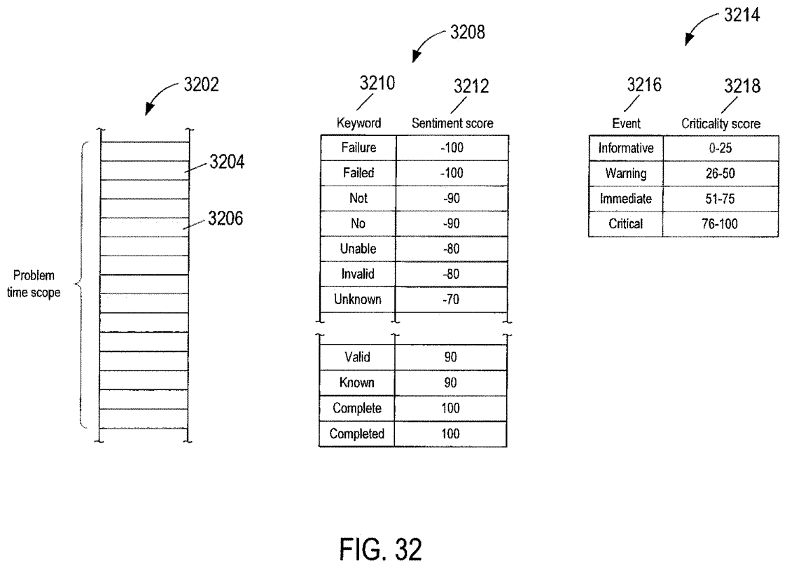

An N_{nc}×N_{nc} correlation matrix of the synchronized sets of non-constant metrics is computed. Each element of the correlation matrix is given by:

$$corr ( {x}^{( i )} , {x}^{( j )} ) = \frac{{\sum }_{k = 1}^{n} ( {x}_{k}^{( i )} - {μ}^{( i )} ) ( {x}_{k}^{( j )} - {μ}^{( j )} )}{{σ}^{( i )} {σ}^{( j )}} \qquad ( 26 )$$

where
i=1, . . . , N_{nc}; and
j=1, . . . , N_{nc}
   FIG. 33 shows an example correlation matrix. The correlation matrix is a square symmetric matrix. The eigenvalues of the correlation matrix are computed. A numerical rank of the correlation matrix is determined from the eigenvalues and a tolerance τ, where 0<τ≤1. For example, the tolerance τ may be in an interval 0.8≤τ≤1. Consider a set of eigenvalues of the correlation matrix given by:

{λₖ}ₖ₌₁^{N}^{_{nc}} (27)

The eigenvalues of the correlation matrix are positive and arranged from largest to smallest (i.e., λₖ≥λₖ₊₁ for k=1, . . . , N_{nc}). The accumulated impact of the eigenvalues is determined based on the tolerance τ according to the following conditions:

$$\begin{matrix}\frac{{λ}_{1} + … + {λ}_{m - 1}}{{N}_{n c}} < τ & ( 28 a ) \\ \frac{{λ}_{1} + … + {λ}_{m - 1} + {λ}_{m}}{{N}_{n c}} \geq τ & ( 28 b )\end{matrix}$$

where m is the numerical rank of the correlation matrix.

The numerical rank m indicates that the set of non-constant metrics {v⁽ⁿ⁾(t)}ₙ₌₁^{N}^{_{nc}} has m independent (i.e., non-correlated) metrics.

Given the numerical rank m, the m independent sets of metric data may be determined using QR decomposition of the correlation matrix. In particular, the m independent metrics are determined based on the m largest diagonal elements of the R matrix obtained from QR decomposition of the correlation matrix.

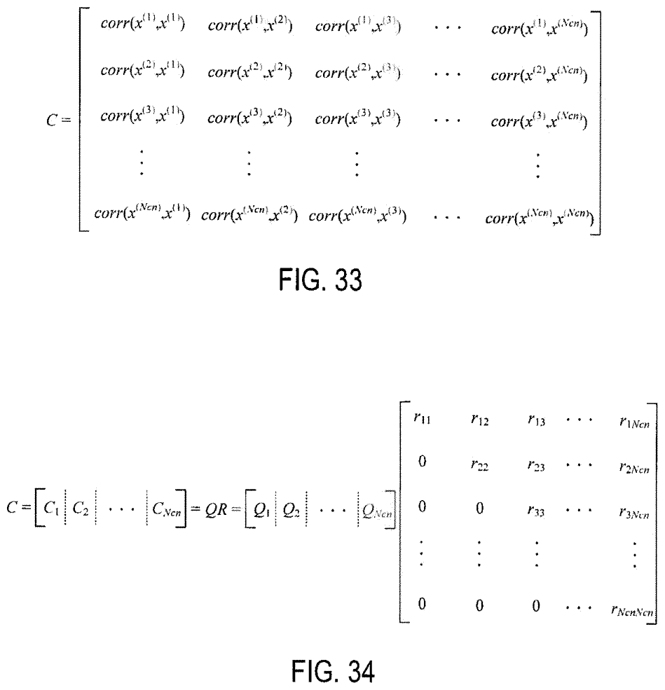

FIG. 34 shows the correlation matrix of FIG. 32 and QR decomposition of the correlation matrix. The N_{nc} columns of the correlation matrix are denoted by C₁, C₂, . . . , C_{N}, N_{nc} columns of the Q matrix are denoted by Q₁, Q₂, . . . , Q_{N}, and N_{nc} diagonal elements of the R matrix are denoted by r₁₁, r₂₂, . . . , r_{NcnNcn}. The columns of the Q matrix are determined based on the columns of the correlation matrix as follows:

$${Q}_{i} = \frac{{U}_{i}}{‖ {U}_{i} ‖} \qquad ( 29 a )$$

where
∥Uᵢ∥ denotes the length of a vector Uᵢ; and
the vectors Uᵢ are calculated according to

$$\begin{matrix}{U}_{1} = {C}_{1} & ( 29 b ) \\ {U}_{i} = {C}_{i} - {\sum }_{j = 1}^{i - 1} \frac{〈 {Q}_{j} , {C}_{i} 〉}{〈 {Q}_{j} , {Q}_{j} 〉} {Q}_{j} & ( 29 c )\end{matrix}$$

where [symbol] ⋅,⋅ [symbol] denotes the scalar product.

The diagonal matrix elements of the R matrix are given by

rᵢᵢ= [symbol] Qᵢ,Cᵢ [symbol] (29d)

The metrics that correspond to the largest m (i.e., numerical rank) diagonal elements of the R matrix are independent (i.e., non-correlated) metrics. Metrics that correspond to the remaining diagonal elements (i.e., less than m) of the R matrix are dependent (i.e., correlated) metrics. As a result, the set of metrics are partitioned into subsets of correlated and non-correlated metrics:

{v⁽ⁿ⁾(t)}ₙ₌₁^{N}^{_{nc}}={v⁽ⁿ⁾(t)}ₙ₌₁^{N}^{_{c}}∪{v⁽ⁿ⁾(t)}ₙ₌₁^{N}^{ₙ} (30)

where
N_{c} is the number of correlated metrics;
Nₙ is the number of non-correlated metrics;
N_{nc}=N_{c}+Nₙ,
{v⁽ⁿ⁾(t)}ₙ₌₁^{N}^{_{c}} is a set of correlated metrics; and
{v⁽ⁿ⁾(t)}ₙ₌₁^{N}^{ₙ} is a set of non-correlated metrics.
   The sets of correlated and non-correlated metrics may be computed as described above over a historical time period. The process described above with reference Equations (25aa)-(30) may be repeated to determine the sets of correlated and non-correlated metrics in a run-time period. Metrics that have switched from the correlated metrics in the historical time period to the set of uncorrelated metrics in the run-time are an interesting pattern.

Anomalous Transactions of Events

An event may be determined by a time, a source of origin, and any attributes associated with the event. An event may be a violation of a threshold by a metric within a time interval. The source of origin of an event may be a server computer, a VM, an application or any object of a distributed computing system. An attribute is any property of an event, such as criticality, username, IP address, and a datacenter ID. For the purpose of determining anomalous transaction of events, events may be denoted by

Eᵢ={r,Aⱼ} (31)

where
Eᵢ is the i-th event;
r is an operational attribute, such as source of the event;
Aⱼ={a₁, a₂, . . . , aₙ} is a j-th package containing n attributes.
   Attributes associated with events are examined first to ensure they are not properties that uniquely identify an event (for example Event ID which is a unique property for every event).

A directed graph is computed from the events and probabilities between the events. The nodes of a directed graph represent an event and the edges connecting nodes represent a conditional probability of the event pairs. In general, a joint probability of a pair of events is given by

$$P ( {E}_{i} , {E}_{j} \vert Δ m ) = \frac{‖ \{ {E}_{i} , {E}_{j} \} ‖}{{\sum }_{i = 1}^{N} ‖ {E}_{i} ‖} \qquad ( 32 )$$

where
Δm is a maximum proximity grap (i.e., time span) where events Eᵢ and Eⱼ are coincident;
∥{Eᵢ,Eⱼ}∥ is the cardinality of the set {Eᵢ, Eⱼ} that is coincident with the proximity gap Δm;
∥Eᵢ∥ is the cardinality of the event Eᵢ that occurs within the proximity gap Δm; and
N is the total number of events Eᵢ.
   The prior probability for an event Eᵢ may be computed using:

$$P ( {E}_{i} ) = \frac{‖ {E}_{i} ‖}{{\sum }_{i = 1}^{N} ‖ {E}_{i} ‖} \qquad ( 33 )$$

Applying Bayes theorem gives the conditional probability of an event Eᵢ given the occurrence of an event Eⱼ given by

$$P ( {E}_{i} \vert {E}_{j} , Δ m ) = \frac{P ( {E}_{i} , {E}_{j} \vert Δ m )}{P ( {E}_{i} )} \qquad ( 34 )$$

The above formulations give the probability that an event will occur along with the probabilities that two specific events occur within proximity Δm, such as a span of time. Once the events and the various probabilities are known for a system, an event graph can be constructed. The events are the nodes of the graph and directed edges are determined by the conditional probabilities given by Equation (33). The direction of an edge connecting two nodes is given by the following convention: given nodes Eᵢ, Eⱼ, and the conditional probability P(Eᵢ|Eⱼ, Δm) the edge connects node Eⱼ to the node Eᵢ. Each edge represents the correction between two events. In other words, each edge represents the probability of the occurrence of the event Eᵢ within the proximity Δm given that the event Eⱼ has already occurred within the proximity Δm.

The graph is reduced by removing non-essential correlation edges. The mutual information contained in the correlation between any two events is given by:

$$I ( {E}_{i} , {E}_{j} ) = log \frac{P ( {E}_{i} , {E}_{j} )}{P ( {E}_{i} ) P ( {E}_{j} )} \qquad ( 35 )$$

where P(Eᵢ, Eⱼ) is the joint probability of events Eᵢ and Eⱼ. The edges connecting the nodes of the graph that represent the connection between the events Eᵢ and Eⱼ are discarded when I(Eᵢ, Eⱼ)<Δ⁺ for I(Eᵢ, Eⱼ)≥0 or when I(Eᵢ, Eⱼ)>Δ⁻ for I(Eᵢ,Eⱼ)<0, where Δ⁺=Q_{0.25}⁺−(0.5+ε)(Q_{0.75}⁺−Q_{0.25}⁺) (similarly for a Δ⁺) and Q_{0.25}⁺ and Q_{0.75}⁺ are the 0.25 and 0.75 quantiles of the edges. The events occurring in the proximity gap are compared to the directed graph. A break from a path of connected nodes in the directed graph is an interesting pattern.

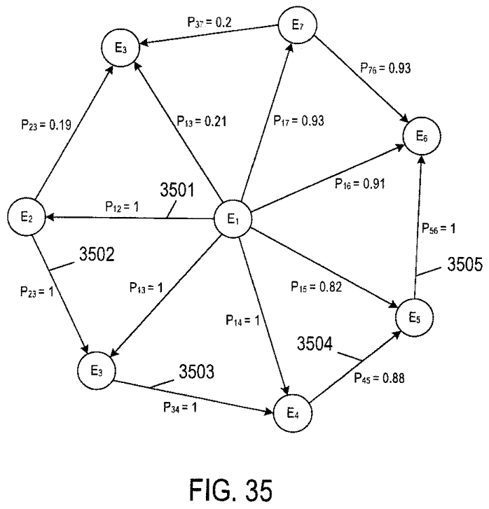

FIG. 35 shows an example of a directed graph formed from eight events. The events, denoted by E₁, E₂, E₃, E₄, E₅, E₆, E₇, and E₈, form the nodes of the graph. Directional arrows represent correlated edges of the graph. A path through of connected nodes represents a transaction of event types. For example, a path represented by edges 3501-3505 represents series of events E₁→E₂→E₃→E₄→E₅→E₆ that are expected to occur one after another within a proximity Δm in accordance with the associated conditional probabilities. Suppose that path stops in a run-time interval is E₁→E₂→E₃→E₄. Failure of the events E₅ and E₆ to occur is an interesting pattern because the event E₅ is expected to occur with a high probability of 0.88. By contrast, occurrence of event E₃ after event E₁ or occurrence of the event E₃ after event E₂ have associated low probabilities are not considered interesting patterns.

A threshold may be used to determine whether failure of an event Eᵢ to occur given that another event Eⱼ has already occurred rises to the level of an interesting pattern. An interesting pattern may be reported when an event Eᵢ failed to occur given the occurrence of event Eⱼ and

P(Eᵢ|Eⱼ,Δm)≥Th_{g} (36)

where Th_{g} is correlated edge threshold (e.g., Th_{g}=0.60)

As an alternative measure for determining whether occurrence of the events Eᵢ and event Eⱼ is an interesting pattern may be determined from the mutual information normalized between [−1,1]. Normalized mutual information is given by

$$NPI ( {E}_{i} , {E}_{j} ) = \frac{I ( {E}_{i} , {B}_{j} )}{h ( {E}_{i} , {E}_{j} )} \qquad ( 37 )$$

where h(Eᵢ,Eⱼ)=−log₂ P(Eᵢ,Eⱼ).

When the normalized mutual information, NPI(Eᵢ,Eⱼ), is close to or equal to −1 (i.e., when 0≤|NPI(Eᵢ,Eⱼ)+1<ε, where ε is a small number, such as 0.1 or 0.01), the probability of the events Eᵢ and Eⱼ occurring together is low and unexpected. Therefore, occurrence of the events Eᵢ and Eⱼ together is identified as an interesting pattern.

Atypical Histogram Distributions

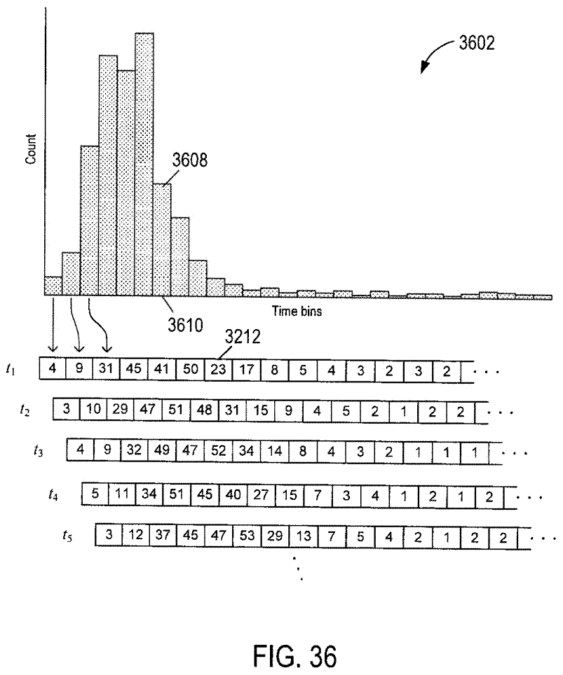

Outlying histogram distributions of the same process over a period time is an interesting pattern to report. FIG. 36 shows an example of a histogram distribution 3602 over a time period. Horizontal axis 3604 represents corresponds to an interval of time that has been divided into time bins. Vertical axis 3606 represents counts. Bars represent counts of occurrences of a metric with metric values that lie within the time limits of the time bins. The metric may be, for example, response times or latencies of an application or hardware within the distributed computing system and each time bin represents a time interval. FIG. 36 includes an example of counts of a metric represented by the histogram distribution 3602. Each box records a count of the metric produced in a time bin. For example, box 3612 records a count of “23” that corresponds to bar 3608. For example, bar 3608 may represents 23 times that the response time of an application to client requests occurred within the limits of the time bin 3610 for a first time interval denoted by t₁. Histogram distributions may be computed for adjacent time intervals. FIG. 36 shows examples of histogram distributions for adjacent and subsequence time intervals denoted by t₁, t₂, t₃, t₄, and t₅.

In order to determine an outlying histogram distribution, the histogram distributions may be normalized. Relative frequencies of counts are computed for the time bins of each histogram distribution to normalized each histogram distribution. A relative frequency of a metric in a time bin is calculated according to

$${d}_{i}^{n} = \frac{{v}_{i}}{{V}_{n}} \qquad ( 38 )$$

where
vᵢ is a count of the number times a metric value of a metric falls within the time limits of the i-th time bin;
n is a histogram distribution index n=1, 2, . . . , N_{H}, where N_{H} is number of histogram distributions; and
Vₙ is the total count of the counts in a time bins of the n-th histogram distribution.
   A histogram distribution for the n-th histogram distribution is given by

Dₙ=(d₁ⁿ,d₂ⁿ,d₃ⁿ, . . . ,d_{M}ⁿ) (39a)

where M is the number of time bins

Each histogram distribution is an M-tuple in an M-dimensional space. In certain implementations, the distance between each pair of histogram distributions may be computed using a cosine distance:

$$Dis {t}_{C S} ( {D}_{i} , {D}_{j} ) = \frac{2}{π} {cos}^{- 1} [ \frac{{\sum }_{m = 1}^{M} {d}_{m}^{i} {d}_{m}^{j}}{\sqrt{{\sum }_{m = 1}^{M} {( {d}_{m}^{i} )}^{2}} \sqrt{{\sum }_{m = 1}^{M} {( {d}_{m}^{j} )}^{2}}} ] \qquad ( 39 b )$$

The closer the distance Dist_{CS}(Dᵢ,Dⱼ) is to zero, the closer the histogram distributions Dᵢ and Dⱼ are to each other. The closer the distance Dist_{CS}(Dᵢ, Dⱼ) is to one, the farther the histogram distributions Dᵢ and Dⱼ are from each other. In another implementation, the distance between histogram distributions may be computed using Jensen-Shannon divergence:

$${Dist}_{JS} ( {D}_{i} , {D}_{j} ) = - {\sum }_{m = 1}^{M} {M}_{m} {log}_{2} {M}_{m} + \frac{1}{2} [ {\sum }_{i = 1}^{M} {d}_{m}^{i} {log}_{2} {d}_{m}^{i} + {\sum }_{i = 1}^{m} {d}_{m}^{j} {log}_{2} {d}_{m}^{j} ] \qquad ( 39 c )$$

where Mₘ=(dₘⁱ+dₘ^{j})/2.

The Jensen-Shannon divergence ranges between zero and one and has the properties that the distributions Dᵢ and Dⱼ are similar the closer Dist_{JS}(Dᵢ, Dⱼ) is to zero and are dissimilar the closer Dist_{JS}(Dᵢ, Dⱼ) is to one. In the following discussion, the distance Dist(Dᵢ, Dⱼ) represents the cosine distance Dist_{CS}(Dᵢ, Dⱼ) or the Jensen-Shannon divergence Dist_{JS}(Dᵢ, Dⱼ). A histogram distribution with a minimum average distance to the other histogram distributions in the M-dimensional space is the baseline histogram distribution. The average distance of each histogram distribution from other histogram distributions is given by:

$$Dis {t}^{A} ( {D}_{i} ) = \frac{1}{{N}_{H} - 1} {\sum }_{j = 1 , j \neq i}^{{N}_{H}} D i s t ( {D}_{i} , {D}_{j} ) \qquad ( 40 )$$

The histogram distribution with the minimum average distance is the baseline histogram distribution denoted by D_{b} for the histogram distributions in the M-dimensional space.

A mean distance from the baseline histogram distribution to other histogram distributions is given by:

$$μ ( {D}_{b} ) = \frac{1}{{N}_{H} - 1} {\sum }_{j = 1 , j \neq b}^{{N}_{H}} D i s t ( {D}_{b} , {D}_{j} ) \qquad ( 41 a )$$

A standard deviation of distances from the baseline histogram distribution to other histogram distributions is given by:

$$std ( {D}_{b} ) = \sqrt{\frac{1}{N - 1} {\sum }_{j = 1 , j \neq b}^{{N}_{H}} {( Dist ( {D}_{b} , {D}_{j} ) - μ ( {D}_{b} ) )}^{2}} \qquad ( 41 b )$$

Discrepancy radii are computed for the baseline histogram distribution as follows:

NDR_{±}=μ(D_{b})±B*std(D_{b}) (42)

where B is an integer number of standard deviations (e.g., B=2 or 3) from the mean in Equation (41a).

A run-time histogram distribution is given by

Dᵣₜ=(d₁^{rt},d₂^{rt},d₃^{rt}, . . . ,d_{M}^{rt}) (43)

An average distance of the run-time histogram distribution Dᵣₜ to the other histogram distributions is computed as follows:

$${Dist}^{A} ( {D}_{r t} ) = \frac{1}{{N}_{H} - 1} {\sum }_{j = 1}^{{N}_{H}} Dist ( {D}_{rt} , {D}_{j} ) \qquad ( 44 )$$

A normal discrepancy radius is centered at the baseline histogram distribution. When the following condition is satisfied

NDR_≤Dist^{A}(Dᵣₜ)≤NDR₊ (45a)

the run-time histogram distribution is not an outlier. On the other hand, when the average distance satisfies either of the following conditions:

Dist^{A}(Dᵣₜ)≤NDR_ or NDR₊≤Dist^{A}(Dᵣₜ) (45b)

the normalized run-time distribution is an outlier distribution and is identified as an interesting pattern.

Other techniques for determining outlier histogram distributions are described in US Publication No. 2019/0163598, published May 30, 2019, owned by VMware Inc. and is hereby incorporated by reference. U.S. Pat. No. 10,402,253 issued Sep. 3, 2019, owned by VMware Inc., also describes techniques for determining outlier histogram distributions and is hereby incorporated by reference.

Atypical Histogram Distributions in Application Traces

Application traces and associated spans may also be used to identify interesting patterns associated with performance problems with objects of the object topology. Distributed tracing is used to construct application traces and associated spans. A trace represents a workflow executed by an application, such as a distributed application. A trace represents how a request, such as a user request, propagates through components of a distributed application or through services provided by each component of a distributed application. A trace consists of one or more spans, which are the separate segments of work represented in the trace. Each span represents an amount of time spent executing a service of the trace.

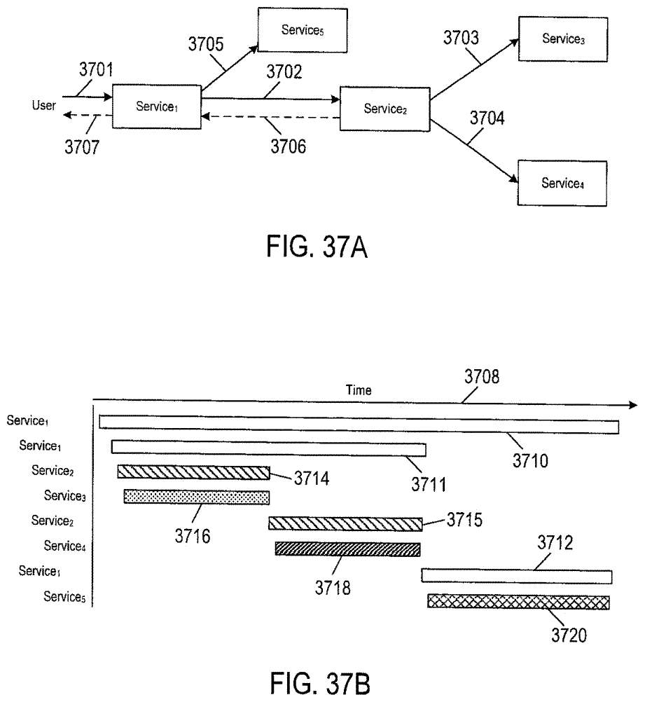

FIGS. 37A-37B show an example of a distributed application and an example application trace, FIG. 37A shows an example of five services provided by a distributed application. The services are represented by blocks identified as Service₁, Service₂, Service₃, Service₄, and Service₅. The services may be web services provided to customers. For example, Service₁ may be a web server that enables a user to purchase items sold by the application owner. The services Service₂, Service₃, Service₄, and Service₅ are computational services that execute operations to complete the user's request. The services may be executed in a distributed application in which each component of the distributed application executes a service in a separate VM on different server computers or using shared resources of a resource pool provided by a cluster of server computers. Directional arrows 3701-3705 represent requests for a service provided by the services Service₁, Service₂, Service₃, Service₄, and Service₅. For example, directional arrow 3701 represents a user's request for a service, such as provided by a web site, offered by Service₁. After a request has been issued by the user, directional arrows 3703 and 3704 represent the Service₁ request for execution of services from Service₂ and Service₃. Dashed directional arrows 3706 and 3707 represent responses. For example, Service₂ sends a response to Service₁ indicating that the services provided by Service₃ and Service₄ have been executed. The Service₁ then requests services provided Service₅, as represented by directional arrow 3705, and provides a response to the user, as represented by directional arrow 3707.

FIG. 37B shows an example trace of the services represented in FIG. 31A. Directional arrow 3708 represents a time axis. Each bar represents a span, which is an amount of time (i.e., duration) spent executing a service. Unshaded bars 3710-3712 represent spans of time spent executing the Service₁. For example, bar 3710 represents the span of time Service₁ spends interacting with the user. Bar 3711 represents the span of time Service₁ spends interacting with the services provided by Service₂. Hash marked bars 3714-3715 represent spans of time spent executing Service₂ with services Service₃ and Service₄. Shaded bar 3716 represents a span of time spent executing Service₃. Dark hash marked bar 3718 represents a span of time spent executing Service₄. Cross-hatched bar 3720 represents a span of time spent executing Service₅.

The example trace in FIG. 37B is a trace that represents normal operation of the services represented in FIG. 37A. In other words, normal operations of the services represented in FIG. 37A are expected to produce a trace with spans of similar duration to the spans of the trace represented in FIG. 37B and therefore is called a trace signature or a trace type for the services provided by the distributed application shown in FIG. 37A. Performance problem with the objects that execute the services of a distributed application include erroneous traces (i.e., traces that fail to approximately match the trace in FIG. 37B) and traces with extended spans or latencies in executing a service.

A trace signature, or typical trace, for services or a distributed application may be defined by nearly identical composition of spans, or by starting points of spans. Trace signatures with a large number of associated erroneous traces are an interesting pattern.

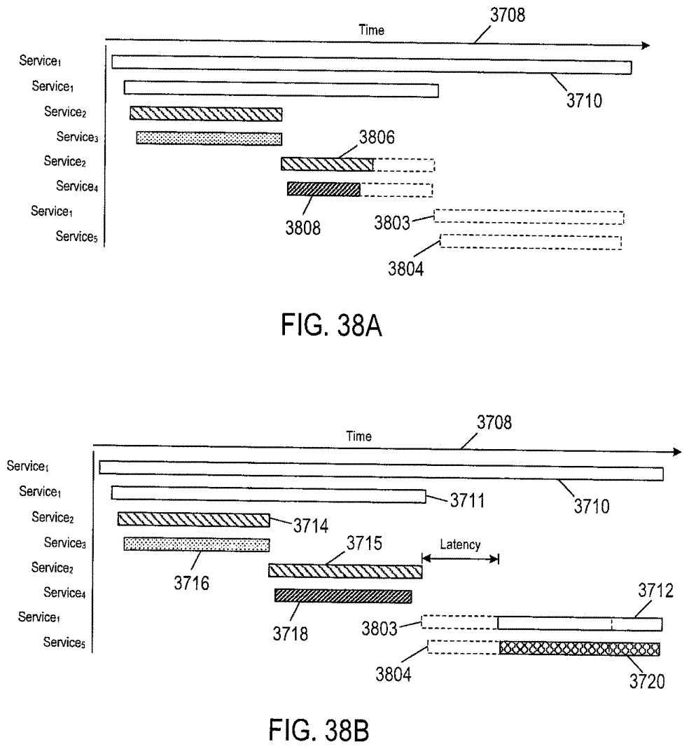

FIGS. 38A-38B show two examples of erroneous traces associated with the services represented in FIG. 37A. In FIG. 38A, dashed line bars 3801-3804 represent normal spans for services provided by Service₁; Service₂, Service₄, and Service₅ as represented by spans 3715, 3718, 3712, and 3720 in FIG. 37B. Spans 3806 and 3808 represent shortened spans for Service₂ and Service₄. No spans are present for Service₁ and Service₅ indicated by dashed bars 3803 and 3804. In FIG. 38B, a latency pushes the spans 3712 and 3720 associated with executing corresponding Service₁ and Service₅ to later times. The erroneous traces illustrated in FIGS. 38A-38B are examples of interesting patterns.

Methods compute the frequency of erroneous traces that have the same trace signature as follows:

$${f}_{trace} = \frac{n ( trace\_error )}{{N}_{t r a c e s}} \qquad ( 46 )$$

where
n(traces_error) is the number of erroneous traces that that correspond to the same trace type; and
N_{traces} is the total number of traces executing within the problem time scope.
   The entropy of erroneous traces that deviate from a normal trace in the problem time scope is calculate by

H(f_{trace})=−log(f_{trace}) (47)

For each trace, a rank of erroneous traces as follows:

$$Rank ( trace ) = \frac{1}{H ( {f}_{t r a c e} )} \qquad ( 48 )$$

The trace rank, Rank(trace), may be used to indicate the importance of the trace.

Methods and systems compute span durations in traces of the same type. Each of the traces may characterized by a trace vector (d₁(s₁), . . . , d_{M}(s_{M})) where sᵢ is a span associated with the i-th service or i-th component of a distributed application, dᵢ is the total time duration of the span sᵢ for the trace, and M is the number of different spans or M different services in traces of the same type executed by the distributed application. The total time duration for a span is given by

$${d}_{i} ( {s}_{i} ) = {\sum }_{j = 1}^{N S} {s}_{i j} \qquad ( 49 )$$

where
NS is the number of times the i-th service or i-th component is executed during execution of the distributed application; and
sᵢⱼ is the span of the j-th time the i-th service or i-th component executed.
   For example, the total time duration of the service, Service₁, in FIGS. 37A-37B is the sum of the spans 3710, 3711, and 3712. The total time duration of the service Service₅ is simply the span 3720. A relative frequency trace vector is computed for multiple same type traces as follows:

$$\begin{matrix}RF = ( {d}_{1}^{norm} ( {s}_{1} ) , … , {d}_{M}^{norm} ( {s}_{M} ) ) & ( 50 a ) \\ where & \\ {d}_{i}^{norm} ( {s}_{i} ) = {\sum }_{j = 1}^{NT} {d}_{i} ( {s}_{i} ) & ( 50 b )\end{matrix}$$

and NT is the number time the distributed application with the same type traces is executed. Outlier traces may be identified using the techniques described in U.S. Pat. No. 10,402,253, issued Sep. 3, 2019, owned by VMware Inc. and is hereby incorporated by reference and using the techniques described in US Publication No. 2019/0163598, filed Nov. 30, 2017, owned by VMware Inc. and is hereby incorporated by reference.

User Verified Problem Instances

Methods and systems provide a graphical user interface that enables a user, such as a system administrator or an application owner, to identify the discovered interesting patterns that explain a problem origin into a problem instance or incidents of a specific kind labeled by the user.

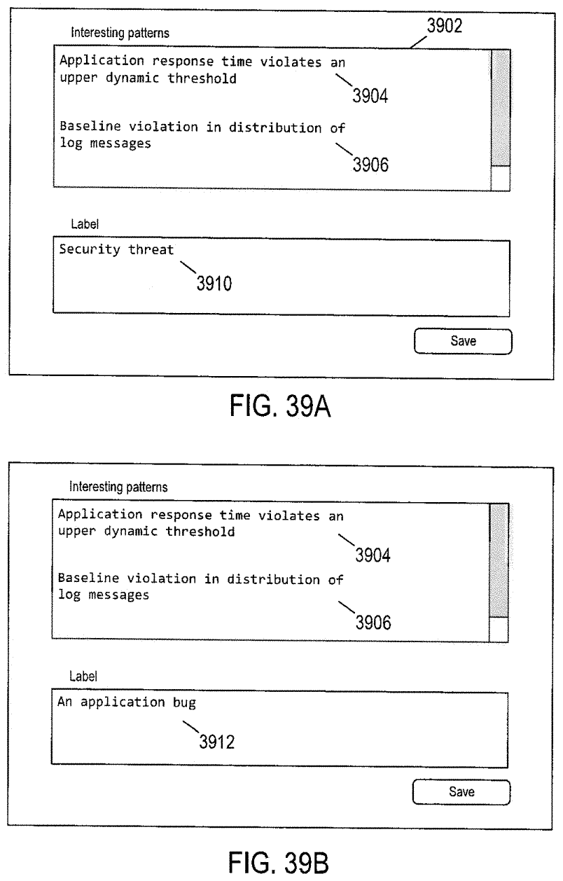

FIG. 39A shows an example of a graphical user interface (“GUI”) that list interesting patterns that have been discovered using the methods described above. In the example, a field 3902 displays a list two interesting patterns 3904 and 3906. The GUI includes a field 3908 that enable a user to enter a label that describes the type of incident associated with discovered interesting patterns. In this example, a user has labeled the incident identified by the interesting patterns 3904 and 3906 as a “security threat” 3910. The user may then save the association between the interesting patterns 3904 and 3906 and the label entered by the user. Because the discovered interesting patterns may also be an indication of an application bug, the user may have decided to use the GUI shown in FIG. 39B to label the same interesting patterns as “an application bug” 3912.

Based on the various types of problems assigned to the interesting patterns, a user may identify a problem associated with certain combinations of interesting patterns and determine corresponding remedial measures for correcting the performance problem. The problems associated the various types of interesting patterns and remedial measures may be stored so that when interesting patterns are present in the future the remedial measures may be executed to correct the performance problems. Remedial measures may be automatically or manually executed to correct the anomalous behavior. Remedial measures include, but are not limited to, increasing the amount of usable capacity of a resource; assigning additional resources to an application; migrating virtual objects; and creating one or more additional virtual objects from a template of the virtual object, the additional virtual objects to share the workload of an object.

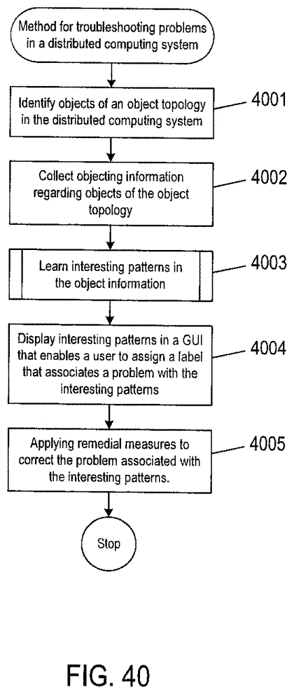

The methods described below with reference to FIGS. 40-48 are stored in one or more data-storage devices as machine-readable instructions that when executed by one or more processors of the computer system, such as the computer system shown in FIG. 1, troubleshoot anomalous behavior in a data center.

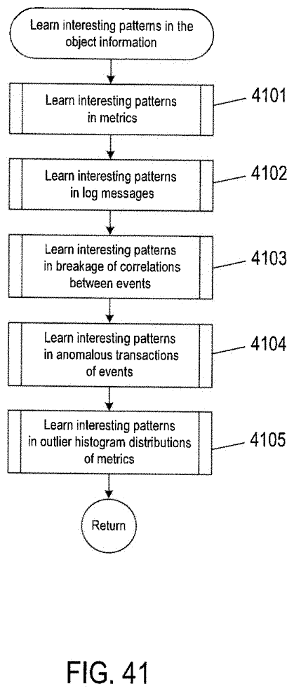

FIG. 40 is a flow diagram illustrating an example implementation of a “method for troubleshooting problems in a distributed computing system.” In block 4001, objects of an object topology in the distributed computing system are identified. In block 4002, object information regarding the objects of the object topology are collected. The object information includes metrics, events, properties, log messages, traces, and network flows. In block 4003, a “learn interesting patterns in the object information” process is performed. An example implementation of “learn interesting patterns in the object information” procedure is described below with reference to FIG. 41. In block 4004, the interesting patterns learned in block 4003 are displayed in a graphical user interface (“GUI”) that enables a user to assign a label identifying the problem associated with the interesting patterns. In block 4005, remedial measures may be applied to correct the problem.

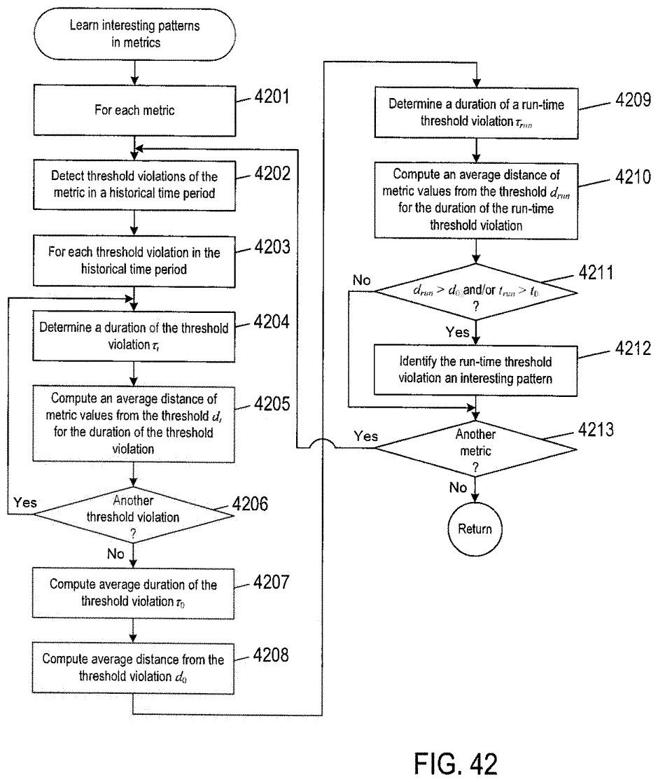

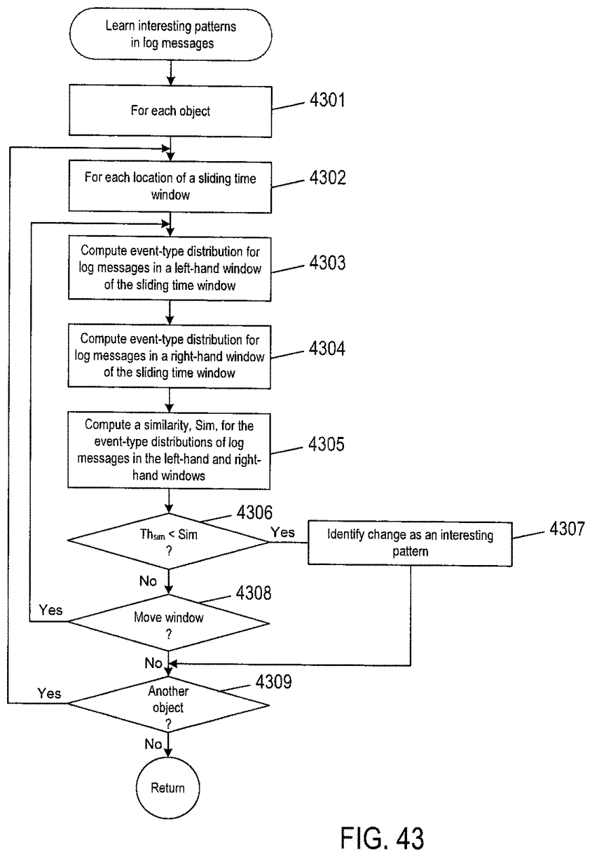

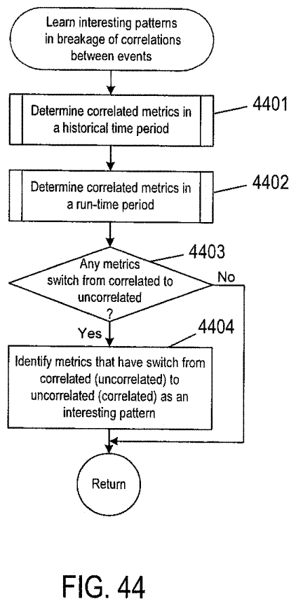

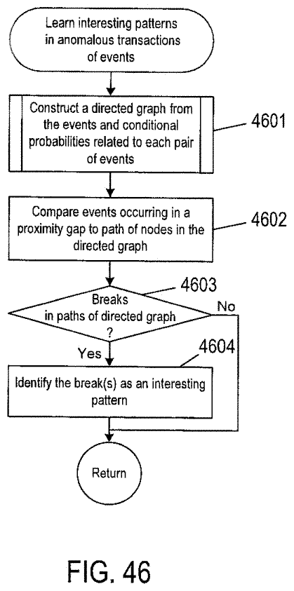

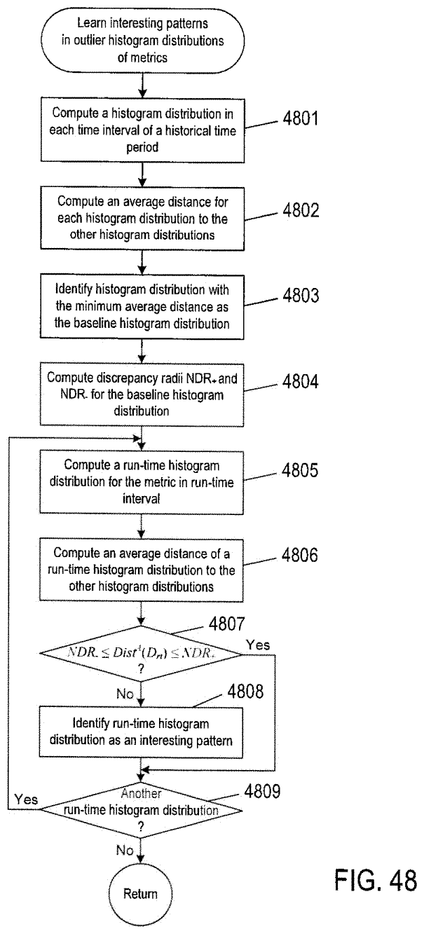

FIG. 41 is a flow diagram illustrating an example implementation of the “learn interesting patterns in the object information” procedure performed in step 4003 of FIG. 40. In block 4101, a “learn interesting patterns in metrics” process is performed. An example implementation of “learn interesting patterns in metrics” procedure is described below with reference to FIG. 42. In block 4102, a “learn interesting patterns in log messages” process is performed. An example implementation of “learn interesting patterns in log messages” procedure is described below with reference to FIG. 43. In block 4103, a “learn interesting patterns in breakage of correlations between events” process is performed. An example implementation of “learn interesting patterns in breakage of correlations between events” procedure is described below with reference to FIG. 44. In block 4104, a “learn interesting patterns in anomalous transactions of events” process is performed. An example implementation of “learn interesting patterns in anomalous transactions of events” procedure is described below with reference to FIG. 46. In block 4105, a “learn interesting patterns in outlier histogram distributions of metrics” process is performed. An example implementation of “learn interesting patterns in outlier histogram distributions of metrics” procedure is described below with reference to FIG. 48.

FIG. 42 is a flow diagram illustrating an example implementation of the “learn interesting patterns in metrics” procedure performed in step 4101 of FIG. 41. A loop beginning with block 4201 repeats the computational operations represented by blocks 4202-4213. In block 4202, threshold violations a metric are detected as described above with reference to FIG. 22A. A loop beginning with block 4203 repeats the computational operations represented by blocks 4204-4205 for each threshold violation. In block 4204, a duration τᵢ is determined for the threshold violation as described above with reference to FIG. 22A. In block 4205, an average distance of metric values from the threshold dᵢ is computed as described above with reference to FIG. 22A. In decision block 4206, blocks 4204 and 4205 are repeated for another threshold violation. In block 4207, an average duration τ₀ is computed as described above with reference to FIG. 22B. In block 4208, an average distance d₀ from the threshold is computed as described above with reference to FIG. 22B. The average duration τ₀ and average distance d₀ are the historical anomaly score for the metric. In block 4209, a run-time duration Tᵣᵤₙ is determined for a run-time threshold violation as described above with reference to FIG. 22A. In block 4210, a run-time average distance of metric values from the threshold dᵣᵤₙ is computed as described above with reference to FIG. 22A. The run-time average duration τᵣᵤₙ and run-time average distance dᵣᵤₙ are the run-time anomaly score for the metric. When the condition in decision block 4211 is satisfied, control flow to block 4212 in which the run-time threshold violation is identified as an interesting pattern. In decision block 4213, blocks 4202-4212 are repeated for another metric.

FIG. 43 is a flow diagram illustrating an example implementation of the “learn interesting patterns in log messages” procedure performed in step 4102 of FIG. 41. A loop beginning with block 4301 repeats the operations represented by blocks 4302-4308 for each object of the object topology. A loop beginning with block 4302 repeats the operations represented by blocks 4303-4307 for each location of a sliding time window in a troubleshooting time period. In block 4303, a first event-type distribution is computed for log messages in a left-hand window of the sliding time window. In block 4304, a second event-type distribution is computed for log messages in a right-hand window of the sliding time window. In block 4305, a similarity is computed for first event-type distribution and the second event-type distribution as described above with reference to Equations (17) and (18). In decision block 4305, when the similarity is greater than a similarity threshold control flows to block 4308. Otherwise control flows to block 4307 and the change in log messages is identified as an interesting pattern. In decision block 4308, blocks 4302-4307 are repeated for another location of the sliding time window. In decision block 4309, blocks 4302-4307 are repeated for another object.

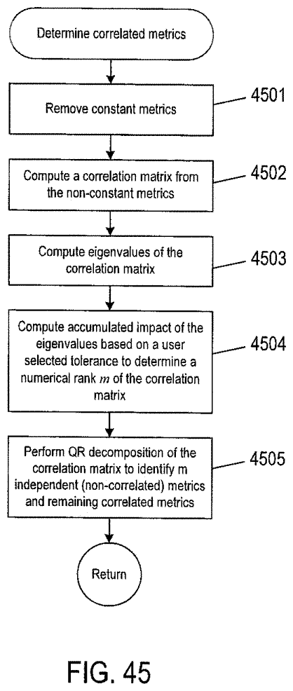

FIG. 44 is a flow diagram illustrating an example implementation of the “learn interesting patterns in breakage of correlations between events” procedure performed in step 4103 of FIG. 41. In block 4401, a “determine correlated metrics in a historical time period” procedure is performed to determine correlated metrics in a run-time period. An example implementation of “determine correlated metrics in a historical time period” procedure is described below with reference to FIG. 45. In block 4402, the “determine correlated metrics in a run-time period” procedure is performed to determine correlated metrics in a run-time period. In decision block 4403, if metrics have change from correlated (uncorrelated) metrics in the historical time period to uncorrelated (correlated) metrics in the run-time period, control flows to block 4404. In block 4404, metrics that switched from correlated (uncorrelated) to uncorrelated (correlated) are identified as an interesting pattern.

FIG. 45 is a flow diagram illustrating an example implementation of the “determine correlated metrics” procedure performed in steps 4401 and 4402 of FIG. 44. In block 4501, constant metrics are discarded as described above with reference to Equations (25a) and (25b). In block 4502, a correlation matrix is computed from non-constant metrics as described above with reference to Equation (26). In block 4503, eigenvalues of the correlation matrix are computed as described above with reference to Equation (27). In block 4504, an accumulated impact of the eigenvalues is computed based on a user selected tolerance to determine a numerical rank m of the correlation matrix as described above with reference to Equations (28a) and (28b). In block 4505, QR decomposition is performed on the correlation matrix to identify the m independent metrics and remaining correlated metrics as described above with reference to Equations (29a)-(29d).

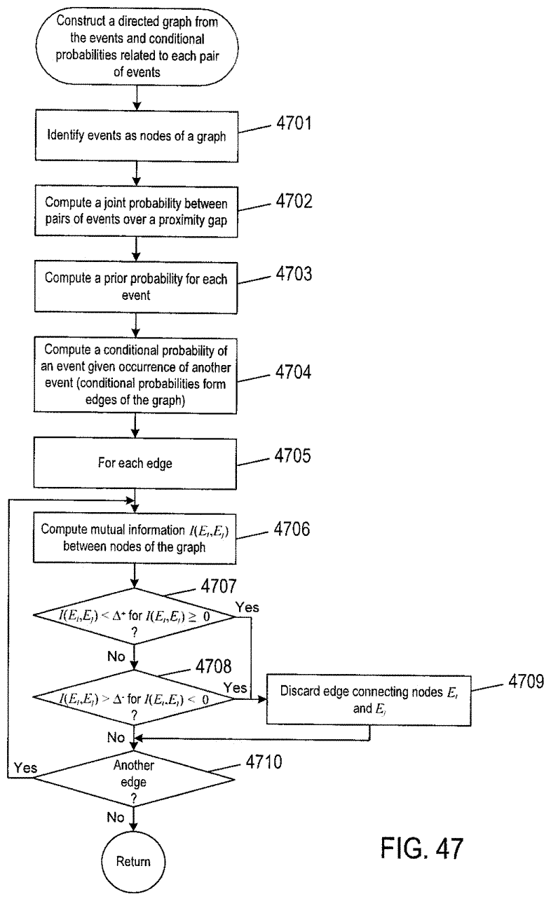

FIG. 46 is a flow diagram illustrating an example implementation of the “learn interesting patterns in outlier histogram distributions of metrics” procedure performed in step 4105 of FIG. 41. In block 4601, a “construct a directed graph from the events and conditional probabilities related to each pair of events” procedure is performed to determine correlated metrics in a run-time period. An example implementation of “construct a directed graph from the events and conditional probabilities related to each pair of events” procedure is described below with reference to FIG. 47. In block 4602, events occurring in a proximity gap are compared to a corresponding path of nodes in the directed graph as described above with reference to FIG. 35. In decision block 4603, when a break from the paths represented in the directed graph is observed as described above with reference to Equation (36) control flow to block 4604. In block 4604, any breaks from paths represented in the directed graph are identified as an interesting pattern.

FIG. 47 is a flow diagram illustrating an example implementation of the “construct a directed graph from the events and conditional probabilities related to each pair of events” procedure performed in step 4601 of FIG. 46. In block 4701, events are identified as nodes in a graph as described above with reference to Equation (31). In block 4702, a joint probability is computed for each pair of nodes of the graph as described above with reference to Equation (32). In block 4703, a prior probability is computed for each event as described above with reference to Equation (33). In block 4704, a conditional probability is computed for each pair of node and are used to inserted directed edges in the graph as described above with reference to Equation (34). A loop beginning with block 4705 repeats the computational operations represented by blocks 4706-4710 for each edge of the directed graph. In block 4706, mutual information is computed for each pair of nodes in the directed graph as described above with reference to Equation (35). When the condition in decision block 4707 is satisfied control flows to block 4709. When the condition in decision block 4708 is satisfied control flows to block 4709. In block 4709, the edge connecting the pair of nodes is discard i.e., trimmed) from the graph. In block 4710, blocks 4706-4709 are repeated for another pair of nodes

FIG. 48 is a flow diagram illustrating an example implementation of the “learn interesting patterns in outlier histogram distributions of metrics” procedure performed in step 4105 of FIG. 41. In block 4801, a histogram distribution computed as described above with reference to FIG. 36 and Equation (37). In block 4802, an average distance for each histogram distribution from each of the other histogram distributions is computed as described above with reference to Equations (39a)-(40). In block 4803, the histogram distribution with the minimum average distance is identified as the baseline histogram distribution. In block 4804, discrepancy radii NDR_{±} are computed for the baseline histogram distribution as described above with reference to Equations (41a)-(42). In block 4805, run-time histogram distribution is computed for the metric in a run-time interval. In block 4806, an average distance of the run-time histogram distribution from the other histogram distributions is computed as described above with reference to Equations (43) and (44). When the condition in decision block 4807 is satisfied, control flows to block 4808. In block 4808, the run-time histogram distribution is identified as an interesting pattern. In decision block 4809, blocks 4805-4808 are repeated for metric collected in another time interval.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An automated method stored in one or more data-storage devices and executed using one or more processors of a computer system for troubleshooting performance problems in a distributed computing system, the method comprising:
collecting object information of objects in the distributed computing system;
learning interesting patterns contained in the object information;
displaying the interesting patterns in a graphical user interface (“GUI”) that enables a user to assign a label identifying a problem associated with the interesting patterns; and
applying remedial measures to correct the problem.

2. The method of claim 1 wherein learning interesting patterns in the object information comprises:
detecting threshold violations of a metric of the objection information in a historical time period;
determining a duration for each threshold violation of the metric in the historical time period;
computing an average distance of metric values from the threshold for each threshold violation in the historical time period;
computing a historical average duration of threshold violations in the historical time period based on the duration of threshold violation in the historical time period;
computing a historical average distance from the threshold based on the average distances of metric values from the threshold in the historical time period;
determining a run-time duration a run-time threshold violation;
determining a run-time average distance of metric values from the threshold for the run-time threshold violation;
when the run-time duration is greater than the historical average duration and the run-time distance is greater than the historical average distance, identifying the run-time threshold violation as an interesting pattern; and
when the run-time duration is greater than the historical average duration or the run-time distance is greater than the historical average distance, identifying the run-time threshold violation as an interesting pattern.

3. The method of claim 1 wherein learning interesting patterns in the object information comprises:
determining correlated and non-correlated metrics of the objection information in a historical time period;
determine correlated and non-correlated metrics in the objection information in a run-time period;
if metrics have change from correlated metrics in the historical time period to non-correlated metrics in the run-time period, identifying metrics that switch to non-correlated metrics in the run-time period as interesting patterns; and
if metrics have change from non-correlated metrics in the historical time period to correlated metrics in the run-time period, identifying metrics that switch to correlated metrics in the run-time period as interesting patterns.

4. The method of claim 1 wherein learning interesting patterns in the object information comprises:
constructing a directed graph from events of the objection information and conditional probabilities related to each pair of events;
comparing events that occur in a proximity gap to a corresponding path of nodes in the directed graph; and
identifying events associated with breaks from the paths in the directed graph as an interesting pattern.

5. The method of claim 1 wherein learning interesting patterns in the object information comprises:
for each time interval of a historical time period, computing a histogram distribution for a metric;
computing an average distance for each histogram distribution to other histogram distributions;
identifying the histogram distribution with a minimum average distance as a baseline histogram distribution;
computing discrepancy radii for the baseline histogram distribution based on a mean distance of the baseline distribution to other histogram distributions and a standard deviation of distances from the baseline histogram distribution to the other histogram distributions;
computing a run-time histogram distribution for the metric in a run-time interval;
computing an average distance from the run-time histogram distribution to the other histogram distributions in the historical time period; and
identifying the run-time histogram distribution as an interesting pattern if the run-time histogram distribution is located outside the discrepancy radii.

6. The method of claim 1 wherein learning interesting patterns in the object information comprises learning of change points in metrics of the objects.

7. The method of claim 1 wherein learning interesting patterns in the object information comprises learning of changes in log messages associated with the objects.

8. The method of claim 1 wherein learning interesting patterns in the object information comprises learning of property changes in the objects.

9. The method of claim 1 wherein learning interesting patterns comprises:
computing normalized mutual information between pair of events; and
when the normalized mutual information between a pair of events is close to minus one and the events are observed as occurring together, identifying a pair of events as an interesting pattern.

10. The method of claim 1 wherein learning interesting patterns comprises computing a rank of erroneous trace types based on a frequency of erroneous trace types.

11. The method of claim 1 wherein learning interesting patterns comprises:
computing a vector of span durations for each trace of the same type of trace;
computing a normalized vector of span durations for the same type of trace; and
determining an outlier trace based on the normalized vector.

12. A computer system for troubleshooting performance problems in a distributed computing system, the system comprising:
one or more processors;
one or more data-storage devices; and
machine-readable instructions stored in the one or more data-storage devices that when executed using the one or more processors controls the system to perform the operations comprising:
collecting object information of objects in the distributed computing system;
learning interesting patterns contained in the object information;
displaying the interesting patterns in a graphical user interface (“GUI”) that enables a user to assign a label identifying a problem associated with the interesting patterns; and
applying remedial measures to correct the problem.

13. The computer system of claim 12 wherein learning interesting patterns in the object information comprises:
detecting threshold violations of a metric of the objection information in a historical time period;
determining a duration for each threshold violation of the metric in the historical time period;
computing an average distance of metric values from the threshold for each threshold violation in the historical time period;
computing a historical average duration of threshold violations in the historical time period based on the duration of threshold violation in the historical time period;
computing a historical average distance from the threshold based on the average distances of metric values from the threshold in the historical time period;
determining a run-time duration a run-time threshold violation;
determining a run-time average distance of metric values from the threshold for the run-time threshold violation;
when the run-time duration is greater than the historical average duration and the run-time distance is greater than the historical average distance, identifying the run-time threshold violation as an interesting pattern; and
when the run-time duration is greater than the historical average duration or the run-time distance is greater than the historical average distance, identifying the run-time threshold violation as an interesting pattern.

14. The computer system of claim 12 wherein learning interesting patterns in the object information comprises:
determining correlated and non-correlated metrics of the objection information in a historical time period;
determine correlated and non-correlated metrics in the objection information in a run-time period;
if metrics have change from correlated metrics in the historical time period to non-correlated metrics in the run-time period, identifying metrics that switch to non-correlated metrics in the run-time period as interesting patterns; and
if metrics have change from non-correlated metrics in the historical time period to correlated metrics in the run-time period, identifying metrics that switch to correlated metrics in the run-time period as interesting patterns.

15. The computer system of claim 12 wherein learning interesting patterns in the object information comprises:
constructing a directed graph from events of the objection information and conditional probabilities related to each pair of events;
comparing events that occur in a proximity gap to a corresponding path of nodes in the directed graph; and
identifying events associated with breaks from the paths in the directed graph as an interesting pattern.

16. The computer system of claim 12 wherein learning interesting patterns in the object information comprises:
for each time interval of a historical time period, comp ting a histogram distribution for a metric;
computing an average distance for each histogram distribution to other histogram distributions;
identifying the histogram distribution with a minimum average distance as a baseline histogram distribution;
computing discrepancy radii for the baseline histogram distribution based on a mean distance of the baseline distribution to other histogram distributions and a standard deviation of distances from the baseline histogram distribution to the other histogram distributions;
computing a run-time histogram distribution for the metric in a run-time interval;
computing an average distance from the run-time histogram distribution to the other histogram distributions in the historical time period; and
identifying the run-time histogram distribution as an interesting pattern if the run-time histogram distribution is located outside the discrepancy radii.

17. The computer system of claim 12 wherein learning interesting patterns in the object information comprises learning of change points in metrics of the objects.

18. The computer system of claim 12 wherein learning interesting patterns in the object information comprises learning of changes in log messages associated with the objects.

19. The computer system of claim 12 wherein learning interesting patterns in the object information comprises learning of property changes in the objects.

20. The computer system of claim 12 wherein learning interesting patterns comprises:
computing normalized mutual information between pair of events; and
when the normalized mutual information between a pair of events is close to minus one and the events are observed as occurring together, identifying a pair of events as an interesting pattern.

21. The computer system of claim 12 wherein learning interesting patterns comprises computing a
rank of erroneous trace types based on a frequency of erroneous trace types.

22. The computer system of claim 12 wherein learning interesting patterns comprises:
computing a vector of span durations for each trace of the same type of trace;
computing a normalized vector of span durations for the same type of trace; and
determining an outlier trace based on the normalized vector.

23. A non-transitory computer-readable medium encoded with machine-readable instructions that implement a method carried out by one or more processors of a computer system to perform the operations comprising:
collecting object information of objects in the distributed computing system;
learning interesting patterns contained in the object information;
displaying the interesting patterns in a graphical user interface (“GUI”) that enables a user to assign a label identifying a problem associated with the interesting patterns; and
applying remedial measures to correct the problem.

24. The medium of claim 19 wherein learning interesting patterns in the object information comprises:
detecting threshold violations of a metric of the objection information in a historical time period;
determining a duration for each threshold violation of the metric in the historical time period;
computing an average distance of metric values from the threshold for each threshold violation in the historical time period;
computing a historical average duration of threshold violations in the historical time period based on the duration of threshold violation in the historical time period;
computing a historical average distance from the threshold based on the average distances of metric values from the threshold in the historical time period;
determining a run-time duration a run-time threshold violation;
determining a run-time average distance of metric values from the threshold for the run-time threshold violation;
when the run-time duration is greater than the historical average duration and the run-time distance is greater than the historical average distance identifying the run-time threshold violation as an interesting pattern; and
when the run-time duration is greater than the historical average duration or the run-time distance is greater than the historical average distance, identifying the run-time threshold violation as an interesting pattern.

25. The medium of claim 19 wherein learning interesting patterns in the object information comprises:
determining correlated and non-correlated metrics of the objection information in a historical time period;
determine correlated and non-correlated metrics in the objection information in a run-time period;
if metrics have change from correlated metrics in the historical time period to non-correlated metrics in the run-time period, identifying metrics that switch to non-correlated metrics in the run-time period as interesting patterns; and
if metrics have change from non-correlated metrics in the historical time period to correlated metrics in the run-time period, identifying metrics that switch to correlated metrics in the run-time period as interesting patterns.

26. The medium of claim 19 wherein learning interesting patterns in the object information comprises:
constructing a directed graph from events of the objection information and conditional probabilities related to each pair of events;
comparing events that occur in a proximity gap to a corresponding path of nodes in the directed graph; and
identifying events associated with breaks from the paths in the directed graph as an interesting pattern.

27. The medium of claim 19 wherein learning interesting patterns in the object information comprises:
for each time interval of a historical time period, computing a histogram distribution for a metric;
computing an average distance for each histogram distribution to other histogram distributions;
identifying the histogram distribution with a minimum average distance as a baseline histogram distribution;
computing discrepancy radii for the baseline histogram distribution based on a mean distance of the baseline distribution to other histogram distributions and a standard deviation of distances from the baseline histogram distribution to the other histogram distributions;
computing a run-time histogram distribution for the metric in a run-time interval;
computing an average distance from the run-time histogram distribution to the other histogram distributions in the historical time period; and
identifying the run-time histogram distribution as an interesting pattern if the run-time histogram distribution is located outside the discrepancy radii.

28. The medium of claim 19 wherein learning interesting patterns in the object information comprises learning of change points in metrics of the objects.

29. The medium of claim 19 wherein learning interesting patterns in the object information comprises learning of changes in log messages associated with the objects.

30. The medium of claim 19 wherein learning interesting patterns in the object information comprises learning of property changes in the objects.

31. The medium of claim 19 wherein learning interesting patterns comprises:
computing normalized mutual information between pair of events; and
when the normalized mutual information between a pair of events is close to minus one and the events are observed as occurring together, identifying a pair of events as an interesting pattern.

32. The medium of claim 19 wherein learning interesting patterns comprises computing a rank of erroneous trace types based on a frequency of erroneous trace types.

33. The medium of claim 19 wherein learning interesting patterns comprises:
computing a vector of span durations for each trace of the same type of trace;
computing a normalized vector of span durations for the same type of trace; and
determining an outlier trace based on the normalized vector.
